(19) United States
(12) Patent Application Publication
(10) Pub. No.: US 2009/0201319 A1
(43) Pub. Date: Aug. 13, 2009

(54) PLASMA DISPLAY PANEL DRIVE METHOD AND PLASMA DISPLAY PANEL DEVICE

(76) Inventors: Hiroyasu Makino, Osaka (JP); Toshikazu Wakabayashi, Osaka (JP); Hideki Ohmae, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 12/375,190

(22) PCT Filed: Sep. 18, 2007
(86) PCT No.: PCT/JP2007/068034

§ 371 Date: Feb. 27, 2009

(30) Foreign Application Priority Data
Sep. 20, 2006 (JP) 2006-254915

(51) Int. Cl. G09G 5/10

(52) U.S. Cl. 345/690; 345/63

(57) ABSTRACT

The aim is to improve the display capability of a PDP at lower gray scale levels by driving the PDP in a manner to adjust the luminance of Gray Scale 1 to an appropriate level. According to the drive method, one TV field is divided into a plurality of subfields SF 1, SF 2 . . . each having a reset period, an address period, and a sustain period. During the address period of SF 1, the sustain electrodes are held at a voltage (potential) Ve1. During the address period in SF 2 and the subsequent subfields, the sustain electrodes are held at a voltage (Ve+Ve2) The voltage Ve1 is higher than the ground voltage and lower than the voltage (Ve+Ve2).

### TECHNICAL FIELD

The present invention relates to a drive method of a plasma display panel and also to a plasma display device.

### BACKGROUND ART

A plasma display panel (herein after simply “PDP”) device includes a PDP having scan electrodes, sustain electrodes, and address electrodes all disposed in an image display area, and also includes a scan electrode drive circuit, a sustain electrode drive circuit, and an address electrode drive circuit connected to the PDP. The respective drive circuits appropriately apply voltage to the corresponding electrodes so that gas discharge occurs in a plurality of discharge cells to emit ultra violet radiation. Being excited by the ultra violet radiation, RGB phosphors emit light to display color images.

Generally, the discharge cells of a PDP has only two display states, which are ON and OFF. The grayscale display is achieved by driving the PDP by a subfield method according to which the illumination time is divided into a plurality of subfields. More specifically, one field period is divided into a plurality of subfields and the discharge cells of the respective colors of RGB achieve grayscale display by combinations of the subfields made to ON.

For example, FIG. 43 shows the configuration of one TV field composed of a plurality of subfields. In the figure, one TV field is composed of eight subfields (herein after, simply “SFs”) and the luminance of respective SFs is weighted in binary to achieve the relative ratio of 1, 2, 4, 8, 16, 32, 64, and 128. With the combinations of 8-bit weighting, the total of 256 gray levels (gray level 0-255) are displayed.

FIG. 44 relates to PDP drive waveforms applied in SF 1 and SF 2, according to one conventional example.

Each SF has a reset period, an address period, and a sustain period.

In the reset period, a reset discharge is generated in discharge cells to erase the history of wall charge having been accumulated in the individual discharge cells and also to form wall charge necessary for subsequent addressing. The reset operation is performed in one of two different ways, one of which is an all-cell reset operation and the other is a selective reset operation. In the all-cell reset operation, a rising ramp waveform is applied to the scan electrodes to cause a reset discharge simultaneity in all the discharge cells. In the selective reset operation, a reset discharge is caused selectively in discharge cells that were made ON in the preceding SF. In the address period that follows, scan pulses are sequentially applied to the scan electrodes and address pulses are applied to address electrodes selected according to an image signal to be displayed. As a result, an address discharge is caused between the scan electrodes and the selected address electrodes and the address discharge eventually spreads to between the scan and sustain electrodes to accumulate wall charge necessary for the subsequent sustain operation.

In the sustain period that follows, sustain pulses are applied between the scan and sustain electrodes a predetermined number of times. As a result, a sustain discharge is caused to emit light, selectively in the discharge cells having the wall charge accumulated by the address discharge.

The number of sustain pulses applied in the discharge sustain period of each SF is determined substantially in proportion to the luminance weighting and in a manner to ensure a sufficient level of luminance in every subfield. In one example, the number of sustain pluses applied in the respective subfields may be determined to be 3, 7, 15, 31, 63, 127, 255, and 511.

Generally, it is desirable to display lower gray levels with increasingly lower luminance to achieve smooth display of lower luminance level gradation. Unfortunately, however, it is usually difficult for PDPs to reduce the relative luminance ratio of lower gray levels and thus difficult to achieve smooth display of lower luminance level gradation.

On the other hand, with CRTS, the luminance difference between Gray Levels 0 and 1, out of the 256 gray levels, is almost 0 cd/m², which ensures smooth grayscale display (“Gray Level 0”, “Gray Level 1”, “Gray Level 2” and so on each indicate a corresponding one of the 256 gray levels). With PDPs, the luminance of Gray Level 1 is higher than that of CRTs, so that the luminance difference between Gray Levels 0 and 1 is as large as 2 cd/m² or more, which makes it difficult to express the luminance gradation as smoothly as that displayed by CRTs. Furthermore, since the overall luminance of PDPs is inherently lower, the error diffusion process (dither method) is not effective to display grayscale images since the images inevitably contain not able jaggies resulting from the error diffusion noise. That is, the effect of error diffusion is not achieved and instead the image quality tends to be degraded.

In order to address the above-noted problems, Patent Documents land 2 focus on a discharge generated in a sustain period and disclose techniques of lowing the luminance of Gray Level 1 by suppressing the sustain discharge in the sustain period for displaying Gray Level 1.

More specifically, according to a drive method suggested by Patent Document 1, the number of sustain pulses applied to display Gray Level 1 is reduced from conventional three times to one time but the pulse duration is made longer than that of sustain pulses applied to display Gray Level 2 or higher. With this arrangement, the luminance of Gray Level 1 is reduced.

Patent Document 2 suggests a drive method according to which the luminance of Gray Level 1 is reduced by applying one sustain pulse having an inclined ramp to weaken the resulting sustain discharge. As it is generally known that a sustain pulse rising gently rather than steeply makes the resulting sustain discharge weak.

Further, Patent Document 3 suggests a drive method according to which no sustain discharge is generated to display Gray Level 1, thereby to reduce the luminance of Gray Level 1. That is, the luminance of Gray Level 1 is produced solely by an address discharge, whereas the luminance of Gray Level 2 and higher is produced by a sustain discharge. Patent Document 3 states that the luminance of Gray Level 1 produced as a result of address discharge caused exclusively between the scan and address electrodes is 0.36 cd/m², whereas the luminance of Gray Level 2 is 0.97 cd/m².

The above drive methods achieve to reduce the luminance of Gray Level 1 as compared with the conventionally known techniques and thus are effective to improve the image display capability at lower gray levels. As of today, products embodying the technique of Patent Document 1 have been commercialized.

### [Patent Document 1]

JP Patent Application Publication No. 2002-014652

### [Patent Document 2]

JP Patent Application Publication No. 2005-107495

### [Patent Document 3]

JP Patent Application Publication No. 2005-157064

### DISCLOSURE OF THE INVENTION

### Problems the Invention is Attempting to Solve

In order to further improve the image display capability of PDPs at lower gray levels, the balance between Gray Levels 1 and 2 in luminance is important, in addition to reduction of the luminance of Gray Level 1. Suppose that the luminance of Gray Level 2 is 1.5 cd/m², it is desirable that the luminance of Gray Level 1 is about half the luminance of Gray Level 2 (about 0.7 cd/m² or so).

Unfortunately, however, with the technique of Patent Document 1, the luminance of Gray Level 1 is already higher than the target luminance (about 0.7 cd/m²), although the luminance is produced exclusively by an address discharge. Thus, it is difficult to achieve the target luminance. Similarly, with the techniques of Patent Documents 2 and 3, it is difficult to appropriately adjust the luminance of Gray Level 1.

The above problem may be addressed by weakening an address discharge thereby to reduce the luminance of Gray Level 1. Yet, with the decrease of the address discharge strength, the delay of a sustain discharge increases and thus the sustain discharge is not sufficiently generated. As a consequence, a strong discharge is caused in the next all-cell reset period, which leads to a reset discharge error. In the next address period, an erroneous discharge is inevitable, which leads to screen flickering and/or jaggies to degrade the image quality.

The present invention is made in view of the above problems and aims to drive a PDP in a manner to improve the image display capability of PDP at lower gray levels by appropriately adjusting the luminance of Gray Level 1, while suppressing occurrence of reset discharge errors.

### Means for Solving the Problems

In order to achieve the above aim, the present invention drives a PDP, by repeating one TV field composed of a plurality of subfields each having a reset period of causing a reset discharge in the discharge cells, an address period of causing an address discharge in discharge cells selected to be ON, a sustain period of causing a sustain discharge in the addressed discharge cells. At least one of the plurality of subfields has, in the reset period, an all-cell reset period and the all-cell reset period includes a voltage (potential) raising period during which the voltage (potential) of first electrodes ramps up at the voltage gradient of 10 V/μs or less. In addition, the present invention has the following features.

Feature A: The plurality of subfields are divided into: a first subfield group composed of one or more subfields including the subfield with the smallest luminance weight; and a second subfield group composed of all the other subfields. In one or more of the subfields that belong to the first subfield group and that at least include the subfield having the smallest luminance weight, the strength of address discharge caused in the address period is reduced as compared with that caused in the address period of any subfield belonging to the second subfield group.

In addition to Feature A, the present invention has one or both of Features B and C below.

Feature B: In one or more of the subfields that belong to the first subfield group and that at least include the subfield having the smallest luminance weight, a positive voltage is applied to the address electrodes during the time a sustain discharge.

Feature C: In an all-cell reset period, a positive voltage is applied to the address electrodes during at least part of the voltage raising period.

Preferably, the positive voltage applied to the address electrodes is not lower than 15 V and not higher than 150 V.

Note that the “one or more of the subfields that belong to the first subfield group and that at least include the subfield having the smallest luminance weight” mentioned above may include (1) a single subfield which is “the subfield with the smallest luminance weight” out of the plurality of subfields constituting one TV field or (2) “the subfield with the smallest luminance weight” and additionally include one or more subfields other than “the subfield with the smallest luminance weight” out of the plurality of subfields constituting one TV field.

It should be noted that even in the case (2), the one or more other subfields additionally included in the first subfield group should be those subfields with relatively small luminance weights. Preferably, the one or more other subfields should be selected from the subfields having the 2nd to 4th smallest luminance weights.

In order to achieve Feature A described above, during the address period of each subfield belonging to the second subfield group, the sustain electrodes need to be held at a first voltage (potential) of positive polarity. In addition, in one or more first group subfields at least including the subfield with the smallest luminance weight, the sustain electrodes need to be held, during the address period, at a second voltage (potential) that is higher than the ground voltage (potential) but lower than the first voltage.

According to the present invention, it is preferable to additionally have the following features.

During the voltage raising period of the all-cell reset period, a negative voltage is applied to the sustain electrodes.

The voltage applied to the address electrodes in the voltage raising period of the all-cell reset period is set higher than the voltage applied to the address electrodes during the address period.

The reset period in the subfield subsequent to the subfield with the smallest luminance weight is determined to be an all-cell reset period.

In the reset period of the subfield next to the subfield with the smallest luminance weight, a selective reset period is provided. During the selective reset period, the voltage applied to the first electrodes is made to ramps down at the voltage gradient of 10 V/μs or less. The all-cell reset period is provided subsequently to the selective reset period.

For each TV field, the PDP device detects the average luminance level of image data and adjusts the magnitude of the second voltage based on the detected average luminance level.

The waveforms applied in one or more first group subfields at least including the subfield with the smallest luminance weight are different from the waveforms applied in the subfields belonging to the second subfield group, in the following respects.

The magnitude of voltage applied to the scan electrodes during the sustain period to generate a sustain discharge is made different.

Either of both of the voltage and pulse width of address pulse applied to the address electrodes during the address period is made different.

The voltage of scan pulse applied to the scan electrodes during the address period is made different.

The most negative voltage (potential) of the scan electrodes during the reset period is made different.

The voltage of the sustain electrodes during the reset period is made different.

In order to stabilize a sustain discharge, the following options are possible: (i) In one or more first group subfields at least including the subfield with the smallest luminance weight, a negative voltage is applied to the sustain electrodes in the sustain period; (ii) In one or more first group subfields at least including the subfield with the smallest luminance weight, the voltage applied to the address electrodes in the sustain period is set higher than the voltage applied to the address electrodes in the address period; and (iii) During the sustain period of each first group subfield, the voltage of only the first one of sustain pulses applied to the scan electrodes is made higher than that of the second and subsequent sustain pulses.

In order to adjust the luminance of lower gray levels, the following options are possible: (i) In the first group subfield with the smallest luminance weight, a waveform having a rising ramp portion that is followed by a steeply rising portion at the voltage gradient of 100 V/μs is applied to the scan electrodes in the sustain period; (ii) In the first group subfield with the smallest luminance weight, a waveform having a single pulsed portion that rises and then decreases the voltage of the scan electrodes is applied.

Among the first group subfields, the last one of the sustain pulses is applied during the sustain period in a manner that the sustain discharge ends relatively later in a subfield with a smaller luminance weight than in a subfield with a larger luminance weight.

It is also preferable that during the reset period that is next to the first group subfield having the second smallest luminance weight, the most negative voltage should be set higher than the most negative voltage during the reset period of the other first group subfields.

It is also preferable to drive the PDP so that none of the discharge cells follows the ON-OFF pattern in which the discharge cell is turned ON in the subfield with the smallest luminance weight, turned OFF in the immediately subsequent subfield, and subsequently turned ON again.

### EFFECTS OF THE INVENTION

According to the present invention, one TV field is composed of a plurality of subfields and the plurality of subfields are divided into: a first subfield group composed of one or more subfields including the subfield with the smallest luminance weight; and a second subfield group composed of the other subfields. One or more first group subfields at least including the subfield with the smallest luminance weight has such an address period in which a weaker address discharge is generated as compared with an address discharge generated in each second group subfield (i.e., Feature A is provided). Thus, the luminance of each subfield having the above feature is reduced to be suitable for lower gray levels (for Gray Level 1).

Generally, the arrangement to weaken an address discharge generated in the address period leads to the risk of discharge delay and thus of insufficient sustain discharge in the sustain period. In such a case, a reset discharge error is likely to occur in the subsequent all-cell reset period. According to the present invention, however, Features B and/or C described in “Means for Solving the Problems” above ensures to stably generate a reset discharge.

That is, by virtue of a positive voltage applied to the address electrodes during the sustain period (i.e., with Feature B), electrons are emitted more easily from the surface of the protective layer of the front panel.

As a result, a sustain discharge is stably caused in the sustain period and thus the reset operation in the subsequent all-cell reset period is stably carried out.

Further, without a sustain discharge in the sustain period, a reset discharge error is likely to occur in the subsequent all-cell reset period. It is considered to be because the reset discharge is likely to first occur between the scan and address electrodes. Yet, by applying a positive voltage to the address electrodes during at least part of the all-cell reset period (with Feature C), it is avoided that the reset discharge starts between the scan and address electrodes. Thus, even if the sustain discharge in the preceding SF is insufficient, it is ensured that a reset discharge is stably generated.

One of Features B and C alone is sufficient to produce the effect of suppressing occurrence of a reset error, so that excellent grayscale display at low luminance levels is ensured without compromising the stability of gray scale display. Yet, with both Features B and C, the synergy effect of Features B and C is expected to further improve grayscale display capability at low luminance levels.

In order to realize Feature A described above, in each second group subfield, the sustain electrodes are held at the first voltage of positive polarity during the address period. In addition, in one or more first group subfields including the subfield with the smallest luminous weight, the sustain electrodes are held at a second voltage during the address period. The second voltage is higher than a ground voltage and lower then that first voltage. With the above arrangement, in each subfield belonging to the second subfield group, the voltage of the sustain electrodes is held at the first voltage during the address period. As a consequence, it is ensured that the address discharge sufficiently spreads to stably perform addressing. In addition, in each subfield belonging to the first subfield group, the spread of address discharge generated between the scan and address electrodes is limited appropriately, so that the luminance of the lowest gray level (i.e., Gray Level 1) is adjusted to about half the luminance of Gray Level 2. With the above noted advantages, an excellent grayscale display is achieved.

According to the present invention, the following features may be added to produce a further effect to appropriately adjust the luminance of a lower gray level (i.e., Gray Level 1) without compromising the stability of the addressing in the second group subfields.

In the voltage rising period of the all-cell reset period, a negative voltage may be applied to the sustain electrodes. As a result, more electrons are emitted from the surface of the protective layer of the front panel, which leads to a further reduction of the risk of reset error.

The voltage applied to the address electrodes in the voltage rising period of the all-cell reset period may be made higher than a voltage applied to the address electrodes in the address period. This arrangement similarly produces the effect of promoting electron emission from the surface of the protective layer of the front panel, which leads to a further reduction of the risk of reset error.

In the reset period of a subfield subsequent to the subfield with the smallest luminance weight, an all-cell reset period may be performed. With this arrangement, even if the discharge cells are made to vary with respect to wall charge accumulated therein in the subfield with the smallest luminance weight, all the discharge cells are uniformly reset immediately thereafter in the all-cell reset period.

The subfield subsequent to the subfield with the smallest luminance weight may have, in the reset period, a selective reset period having a voltage decreasing period during which a voltage of the first electrodes ramps down at a voltage gradient of 10 V/μs or less. With this arrangement, an all-cell reset discharge is generated with higher stability in the all-cell reset period.

According to the present invention above, the average luminance level of image data may be detected per TV field, and a magnitude of the second voltage may be adjusted based on the detected average luminance level. With this arrangement, necessary image characteristics are ensured in accordance with the luminance of display image.

The voltage applied to the scan electrodes during a sustain discharge in the sustain period may be made different between (i) said one or more first group subfields including the subfield with the smallest luminous weight and (ii) the second group subfields. With this arrangement, the strength of a sustain discharge in the respective groups of subfields may be adjusted separately. In this case, the subfield in which the voltage applied to the scan electrodes is set to relatively high is enabled to generate a sustain discharge with higher stability.

At least either of the voltage and width of address pulse applied to the address electrodes in the address period may be made different between (i) at least one of the first group subfield with the smallest luminance weight and (ii) each second group subfield. With this arrangement, the extent to which an address discharge spreads may be adjusted separately in the respective groups of subfields. In this case, the setting of address pulse to a higher voltage and to a wider pulse width results in a stronger address discharge and thus in a higher luminance produced by the address discharge.

The voltage of a scan pulse applied to the scan electrodes in the address period may be made different between (i) at least one of the first group subfield with the smallest luminance weight and (ii) each second group subfield. This arrangement also makes it possible to adjust the extent to which an address discharge spreads separately in the respective groups of subfields. In this case, the setting of scan pulse to a higher voltage results in a stronger address discharge and thus in a higher luminance produced by the address discharge.

The most negative voltage of the scan electrodes during the reset period may be made different between (i) at least one of the first group subfield with the smallest luminance weight and (ii) each second group subfield. This arrangement also makes it possible to adjust the extent to which an address discharge spreads separately in the respective groups of subfields.

The voltage of the sustain electrodes in the reset period may be made different between (i) at least one of the first group subfield with the smallest luminance weight and (ii) each second group subfield. This arrangement also makes it possible to adjust the extent to which an address discharge spreads separately in the respective groups of subfields.

In one or more first group subfields including the subfield with the smallest luminous weight, a negative voltage may be applied to the sustain electrodes in the sustain period. With this arrangement, a sustain discharge is generated with higher stability.

In one or more first group subfields including the subfield with the smallest luminous weight, a voltage applied to the address electrodes may be made higher in the sustain period than in the address period. This arrangement is also desirable to generate a sustain discharge with higher stability.

In each first group subfield, the voltage of only a first one of sustain pulses applied to the scan electrodes during the sustain period may be raised. This arrangement is also desirable to generate a sustain discharge with higher stability.

In the first group subfield with the smallest luminance weight, the waveform applied to the scan electrodes in the sustain period may include a rising ramp portion that is followed by a steeply rising portion. Although this arrangement inevitably lengthen the sustain period because of the ramp portion, the emission intensity produced by a sustain discharge is decreased to suitably adjust the luminance of lower gray levels.

In the first group subfield with the smallest luminance weight, the waveform applied to the scan electrodes in the sustain period may include a single pulsed portion that raises and then decreases a voltage of the scan electrodes. With this arrangement, the sustain discharge is erased with the falling edge of the pulse, which is effective to appropriately reduce the luminance of lower gray levels.

In general, in a subfield having a smaller luminance weight, a fewer sustain pulses are applied to accumulate a relatively smaller amount of wall charge. Thus, it is relatively difficult to reliably perform an erase operation. According to the present invention, however, the last one of sustain pulses applied during the sustain period may be controlled to end relatively later in a subfield with a smaller luminance weight among the first group subfields than in a subfield with a larger luminance weight. With this arrangement, the duration of an erase operation is extended to reliably perform an erase operation.

In the subfield subsequent to one of the first group subfields with a second smallest luminance weight, the most negative voltage during the reset period may be set higher than the most negative voltage during the reset period of each of the other first group subfields. This arrangement is effective to reduce the risk of illumination failure in green discharge cells.

The plasma display panel may be driven so that none of the discharge cells follows an ON-OFF pattern in which the discharge cell is turned ON in the subfield with the smallest luminance weight, turned OFF in an immediately subsequent subfield, and subsequently turned ON. This arrangement is effective to prevent color defects resulting from illumination failure.

### BRIEF DESCRIPTION OF THE DRAWINGS

FIG. 1 is a view showing the structure of a PDP consistent with one embodiment of the present invention;

FIG. 2 is a view showing the structure of a drive unit for driving the PDP;

FIG. 3 is a view showing drive voltage waveforms applied by respective drive circuits of Example 1 to corresponding electrodes of the PDP;

FIG. 4 is a view showing a scan electrode drive circuit according to Example 1;

FIG. 5 is a view showing a level change circuit used in the scan electrode drive circuit;

FIG. 6 is a view showing an alternative level change circuit used in the scan electrode drive circuit;

FIG. 7 is a view showing an alternative scan electrode drive circuit according to Example 1;

FIG. 8 is a view showing a sustain electrode drive circuit according to Example 1;

FIG. 9 is a view showing a level change circuit used in the sustain electrode drive circuit;

FIG. 10 is a view showing an alternative level change circuit used in the sustain electrode drive circuit;

FIG. 11 is a view showing an alternative level change circuit used in the sustain electrode drive circuit;

FIG. 12 is a view showing an alternative level change circuit used in the sustain electrode drive circuit;

FIG. 13 is a view showing an alternative level change circuit used in the sustain electrode drive circuit;

FIG. 14 is a view showing an alternative level change circuit used in the sustain electrode drive circuit;

FIG. 15 is a view showing an alternative level change circuit used in the sustain electrode drive circuit;

FIG. 16 is a view showing an alternative level change circuit used in the sustain electrode drive circuit;

FIG. 17 is a view showing an alternative level change circuit used in the sustain electrode drive circuit;

FIG. 18 is a view showing an alternative level change circuit used in the sustain electrode drive circuit;

FIG. 19 is a view showing an address electrode drive circuit according to Example 1;

FIG. 20 is a view showing a level change circuit used in the address electrode drive circuit;

FIG. 21 is a view showing an alternative level change circuit used in the address electrode drive circuit;

FIG. 22 is a view showing drive voltage waveforms applied by respective drive circuits of Example 2 to corresponding electrodes of the PDP;

FIG. 23 is a view showing a sustain electrode drive circuit according to Example 2;

FIG. 24 is a view showing an alternative sustain electrode drive circuit according to Example 2;

FIG. 25 is a view showing an alternative sustain electrode drive circuit according to Example 2;

FIG. 26 is a view showing an alternative sustain electrode drive circuit according to Example 2;

FIG. 27 is a view showing an alternative sustain electrode drive circuit according to Example 2;

FIG. 28 is a view showing an address electrode drive circuit according to Example 2;

FIG. 29 is a view showing an alternative address electrode drive circuit according to Example 2;

FIG. 30 is a view showing an alternative address electrode drive circuit according to Example 2;

FIG. 31 is a view showing an alternative address electrode drive circuit according to Example 2;

FIG. 32 is a view showing drive voltage waveforms applied by respective drive circuits of Example 3 to corresponding electrodes of the PDP;

FIG. 33 are views showing results of experiments conducted according to the drive method of Example 3;

FIG. 34 is a view showing drive voltage waveforms applied the respective drive circuits of Example 4 to corresponding electrodes of the PDP;

FIG. 35 is a view showing drive voltage waveforms applied by respective drive circuits of Example 5 to corresponding electrodes of the PDP;

FIG. 36 is a view showing drive voltage waveforms applied by respective drive circuits of Example 6 to corresponding electrodes of the PDP;

FIG. 37 shows tables illustrating occurrence of horizontal crosstalk in relation to occurrence of illumination failure;

FIG. 38 is a view showing drive voltage waveforms applied by respective drive circuits of Example 7 to corresponding electrodes of the PDP;

FIG. 39 shows tables illustrating occurrence of horizontal crosstalk in relation to occurrence of illumination failure;

FIG. 39 is a view showing drive voltage waveforms applied by respective drive circuits of Example 8 to corresponding electrodes of the PDP;

FIG. 40 is a view showing drive voltage waveforms applied by the respective drive circuits of Example 9 to the corresponding electrodes of the PDP;

FIG. 42 is a view showing drive voltage waveforms applied by respective drive circuits of Examples 1-9 to corresponding electrodes of the PDP;

FIG. 43 is a view showing the configuration of one TV field composed of a plurality of subfields; and

FIG. 44 is a view showing drive waveforms according to a conventional example.

### REFERENCE NUMERALS

PA1 Front Panel
PA2 Back Panel
14 Address Electrodes
19a Scan Electrodes
19b Sustain Electrodes
20 Discharge Space
21 Scan Electrode Drive Circuit
22 Sustain Electrode Drive Circuit
23 Address Electrode Drive Circuit
24 Timing Generation Circuit
L, L2, L3 Level Change Circuit

### BEST MODE FOR CARRYING OUT THE INVENTION

A PDP device is composed of a PDP and a drive circuit.

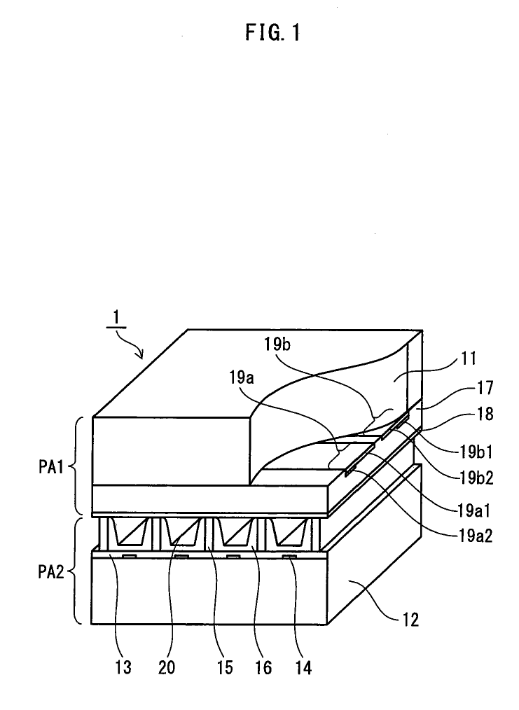

FIG. 1 is a view showing the structure of a PDP 1 consistent with one embodiment of the present invention.

The PDP 1 is basically identical in structure to a conventional PDP and includes a front panel PA 1 and a back panel PA2 that are joined together.

The front panel PA 1 includes: a front glass substrate 11; a plurality of discharge electrode pairs each made up of a scan electrode 19a and a sustain electrode 19b disposed in stripes on the front glass substrate 11; and a dielectric layer 17 and a protective layer 18 layered in a manner to cover the scan and sustain electrodes 19a and 19b. Each scan electrode 19a is composed of a transparent electrode 19a1 and a metal electrode 19a2. Similarly, each sustain electrode 19b is composed of a transparent electrode 19b1 and a metal electrode 19b2.

The back panel PA2 includes: a back glass substrate 12; a plurality of address electrodes 14 disposed in stripes on the back glass substrate 12; a dielectric layer 13 disposed to cover the address electrodes 14; and barrier ribs 15 formed on the dielectric layer 13.

The discharge electrode pairs intersect the address electrode 14 in plan view. At a position corresponding to each intersection, a discharge cell is formed. The barrier ribs 15 may be in the shape of stripes parallel to the address electrode 14 or in a box-like shape enclosing a discharge space 20 of a corresponding discharge cell.

The inner surfaces of the barrier ribs 15 are coated with phosphor layers 16. Generally, the phosphor layers 16 are of red, green, and blue that are sequentially arranged to realize color display.

Each discharge space 20 partitioned with the barrier ribs 15 is filled with a discharge gas.

The PDP further includes the following drive circuits: a scan electrode drive circuit for driving the scan electrodes, a sustain electrode drive circuit for driving the sustain electrodes, and an address electrode drive circuit for driving the address electrodes. The respective drive circuits appropriately apply voltage to the electrodes so that gas discharge occurs in a plurality of discharge cells to emit ultra violet radiation. Being excited by the ultra violet radiation, the phosphors of RGB emit light to display color images.

### (Overall Structure of Drive Unit)

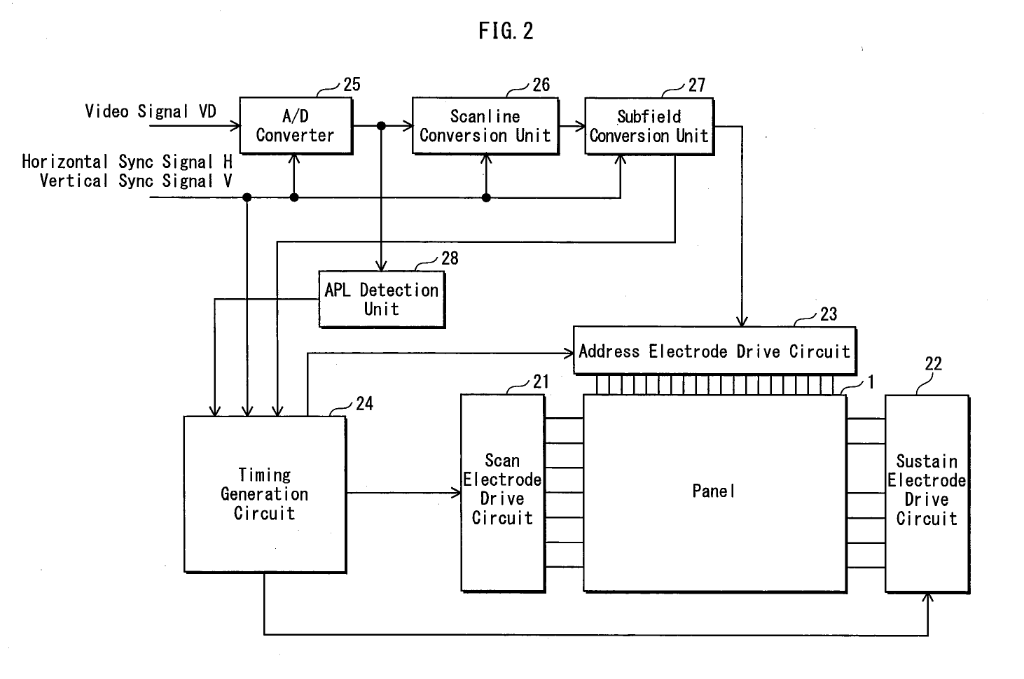

FIG. 2 is a view showing the structure of a drive unit for driving the PDP 1.

As shown in FIG. 2, the drive unit includes a scan electrode drive circuit 21, a sustain electrode drive circuit 22, an address electrode drive circuit 23, a timing generation circuit 24, an A/D (Analog/Digital) conversion unit 25, a scanline conversion unit 26, a subfield conversion unit 27, and an APL (Averaged Picture Level) detection unit 28.

In the drive unit, a video signal VD is input to the A/D conversion unit 25, where as a horizontal sync signal H and vertical sync signal V are input to the A/D conversion unit 25 and the subfield conversion unit 27. The vertical sync signal V is also input to the timing generation circuit 24.

The A/D conversion unit 25 converts the received video signal VD into digital image data and outputs the resulting image data to the scanline conversion unit 26 and also to the APL detection unit 28.

The scanline conversion unit 26 converts the image data received from the A/D conversion unit 25 into image data in accordance with the number of pixels of the PDP 1 and outputs the resulting image data to the subfield conversion unit 27. The subfield conversion unit 27 has a subfield memory (not shown) and converts image data transferred from the scanline conversion unit 26 into subfield data and temporarily stores the subfield data in the subfield memory. The subfield data is a set of pieces of binary data indicating ON/OFF of the individual discharge cells in the respective subfields. The PDP 1 displays grayscale images based on the subfield data. The subfield conversion unit 27 outputs subfield data to the scan electrode drive circuit 21 in accordance with a timing signal supplied from the timing generation circuit 24.

The APL detection unit 28 detects the average luminance level of image data. The drive unit may use the detected average luminance level to control a drive waveform.

The timing generation circuit 24 generates a field start signal a predetermined time period after the vertical sync signal V. Starting from the field start signal, the timing generation circuit 24 generates timing signals indicating the start timing of the reset period, address period, and sustain period of each subfield. Also, the timing generation circuit 24 keeps counts of clock pulses starting from the respective timing signals to generate timing signals indicating the pulse generation timing and outputs the resulting signals to the drive circuits 21-23.

To this end, the timing generation circuit 24 stores the numbers of clock pluses CLK corresponding to the predetermined durations from the start of each subfield to the rising of a pulse and to the falling of the pulse. Upon the start of a subfield, the timing generation circuit 24 resets a time counter CT and when the time counter CT reaches the numbers corresponding to the predetermined durations, the timing generation circuit 24 instructs the respective drive circuits 21-23 as to the timing of rising and falling of a pulse.

Each of the drive circuits 21-23 has, for example, a known driver IC and applies drive pulses to the PDP 1 in the following manner, in accordance with timing signals supplied from the timing generation circuit 24.

The scan electrode drive circuit 21 applies pulses such as scan and sustain pulses to the scan electrodes SCN, in accordance with timing signals supplied from the timing generation circuit 24.

The sustain electrode drive circuit 22 applies pulses such as sustain pulses to the sustain electrodes SUS, in accordance with timing signals supplied from the timing generation circuit 24.

The address electrode drive circuit 23 has a group of address ICs and applies, during an address period, address pulses to electrodes selected from the address electrodes D based on subfield data, in accordance with timing signals supplied from the timing generation circuit 24.

Note that each of the scan electrode drive circuit 21, the sustain electrode drive circuit 22, and the address electrode drive circuit 23 has a level change circuit for changing the voltage (potential) of the scan electrodes, the sustain electrodes, or the address electrodes in multiple levels.

The following describes the drive waveforms applied by the respective drive circuits to the corresponding electrodes.

In general, a PDP is driven by the subfield method. As is known, TV broadcast images according to the NTSC standard is composed of 60 TV fields per second. One TV field is composed of a plurality of subfields (herein after “SFs”) to divide illumination time of red, green, and blue discharge cells to express halftone colors by combinations of the subfields.

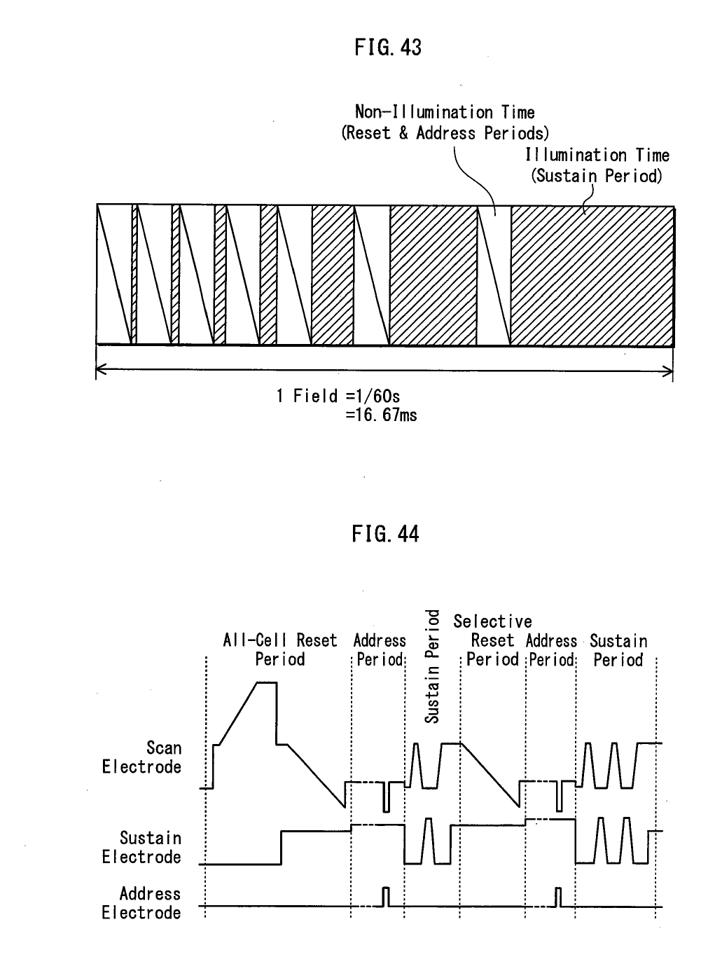

In the drive method according to this embodiment, similarly to the TV field configuration shown in FIG. 43, one TV field is composed of a plurality of subfields (SF 1, SF 2, SF 3 . . . each assigned with different luminance weights.

SF 1 is the lowest gray level SF corresponding to Gray Level 1.

Each SF excluding SF 1 (i.e., SF 2 and subsequent SFs) correspond to Gray Level 2 or higher and has a reset period, an address period, and a sustain period. In the sustain period of each SF, the number of sustain pulses approximately proportional to the weighting of the subfield is applied. That is, in SF 2, as many sustain pulses as the number corresponding to Gray Level 2 are applied. Similarly, in SF 3, as many sustain pulses as the number corresponding to Gray Level 3 are applied.

According to this embodiment, the plurality of subfields (SF 1, SF 2, and SF 3 . . . ) constituting one TV field is divided into a first subfield group and a second subfield group. The first subfield group includes one or more subfields with relatively small luminance weights, and at least SF 1 with the smallest luminance weight is included in the first subfield group, and the second subfield group includes all the other subfields (Note that each subfield belonging to the first group subfield may also be referred to as a “first group subfield” and each subfield belonging to the second group subfield may also be referred to as a “second group subfield”). The voltage applied to the respective electrodes are made different between the first and second subfield groups. That is to say, this embodiment has Feature A and also has either or both of Features B and C described below.

Feature A: In one or more first group subfields at least including the subfield with the smallest luminance weight, the address discharge caused in the address period is made weaker as compared with the address discharge caused in the address period of each second group subfield.

Feature B: In one or more first group subfields at least including the subfield with the smallest luminance weight, a positive voltage is applied to the address electrodes during the time of a sustain discharge.

Feature C: At least one of the plurality of subfields has, in the reset period, an all-cell reset period having a voltage (potential) rising period. During the voltage rising period, the voltage applied to the first electrodes ramps up at the voltage gradient of 10 V/μs or less. In addition, a positive voltage is applied to the address electrodes at least during part of the voltage raising period in the all-cell reset period.

In order to realize the above-described Feature A, the sustain electrodes are maintained at a first voltage (potential) of positive polarity during the address period of each second group subfield. In addition, in one or more first group subfields at least including the subfield with the smallest luminance weight, the sustain electrodes are maintained at a second voltage (potential) during the address period. The second voltage is higher than the ground voltage (potential) but lower than the first voltage.

Note that the first subfield group may include only SF 1 which has the smallest luminance weight. Alternatively, the first subfield group may include, in addition to SF 1, one or more subfields selected from SF 2, SF 3, and SF 4. In the following Examples, the first subfield group includes SF 1 only and the second subfield group includes SF 2 and the subsequent subfields.

The following specifically describes the drive method by way of the following Examples.

### Example 1

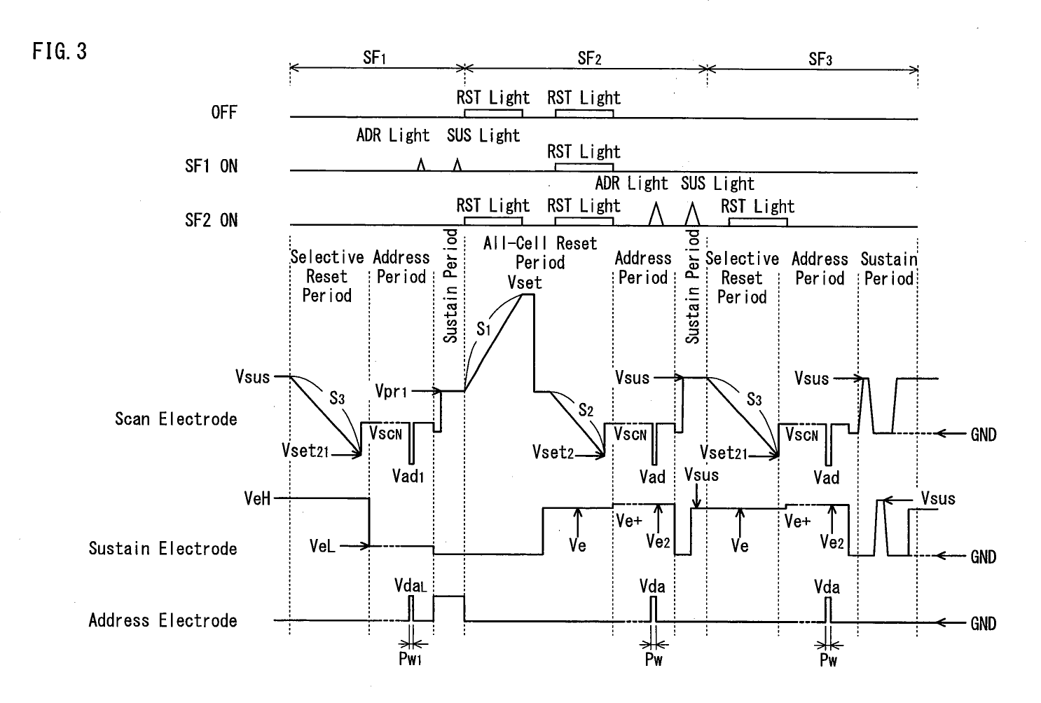

FIG. 3 is a view showing drive voltage waveforms applied by the respective drive circuits of Example 1 to the corresponding electrodes of the PDP in the subfields corresponding to Gray Levels 1-3 (SFs 1-3).

Although FIG. 3 does not show SF 4 and subsequent subfields, the drive waveforms are identical to those applied in SF 3, except for the number of sustain plusses.

The following sequentially describes the reset period, address period, and sustain period.

### Reset Period:

In the reset period, a reset pulse is applied to all the scan electrodes at once to generate a weak discharge in all the discharge cells. As a result, the history of wall charge (i.e., residual wall charge) is erased from each discharge cell and accumulate wall charge necessary for the subsequent addressing.

The reset operation is performed in one of two different ways. One is an all-cell reset operation of applying a rising ramp waveform to the scan electrodes to cause a reset discharge in all the discharge cells at once. The other is a selective reset operation of causing a reset discharge only in the discharge cells that were made ON in the preceding SF.

In Example 1, SF 2 in each TV field has an all-cell reset period in which an all-cell reset pulse is applied to all the scan electrodes to generate a reset discharge in all the discharge cells. The other SFs (i.e., SF 1, SF 3, and SFs subsequent to SF 3) has a selective reset period in which a reset pulse is applied to selected ones of the scan electrodes to generate a reset discharge only in the discharge cells in which a sustain discharge was generated in the preceding subfield.

As shown in FIG. 3, the all-cell reset pulse applied in SF 2 has, at the leading edge thereof, a rising ramp portion S1 that rises to the most positive voltage (potential) Vset (V) at a positive and gentle gradient (voltage gradient 10 V/μs or less). For the duration of the rising ramp portion S1, the sustain electrodes and the address electrodes are basically maintained at the ground voltage 0 V.

With application of the rising ramp portion S1, the voltage difference within the discharge space exceeds the breakdown voltage, so that a weak gas discharge is generated in the discharge space (weak discharge in which the ionization multiplication undergoes slowly). As a consequence, electrical charges produced by the gas discharge is accumulated as wall charge on and around the address, scan, and sustain electrodes at portions enclosing the discharge space. The wall charge reduces the electric field between the discharge space and the surfaces of electrodes, because a negative charge accumulates on the surface of the protective layer at locations near the sustain electrodes, whereas a positive charge is accumulated on the surface of the protective layer at locations near the sustain electrodes as well as on the surface of the phosphor layer 16 at locations near the address electrodes.

The all-cell reset pulse has, at the trailing edge thereof, a falling ramp portion S2 that falls to the most negative voltage (potential) Vset2 (V) at a negative and gentle gradient (voltage gradient 10 V/μs or less).

With application of the falling ramp portion S2, the voltage of the scan electrodes is switched from positive to negative and a weak discharge is generated during the voltage switching, which serves to reduce the negative charge accumulated on the surface of the protective layer at locations near the scan electrodes and also reduce the positive wall charge accumulated on the surface of the protective layer at locations near the sustain electrodes.

As described above, a weak discharge is caused twice to evenly reset all the discharge cells and a suitable wall voltage for the subsequent addressing is obtained between the scan, address, and sustain electrodes.

By performing the all-cell reset in SF 2 that is subsequent to SF 1, all the discharge cells are evenly reset regardless of whether the individual discharge cells were made ON or OFF in SF 1.

The selective reset pulse applied to the scan electrodes in each of SF 1, SF 3, and SFs subsequent to SF3 has a falling ramp portion S3. As shown in FIG. 3, the falling ramp portion S3 falls from a voltage (potential) Vsus (V) to the voltage Vset2 (V) gently (at the voltage gradient of 10 V/μs or less).

By applying the selective reset pulse, a weak discharge is generated selectively in the discharge cells in which a sustain discharge was generated in the sustain period of the preceding subfield. As a result, in the related discharge cells, the wall voltage across scan, address, and sustain electrodes is reduced to fall within a range appropriate for the subsequent addressing and the wall voltage on the address electrodes is also adjusted appropriately. On the other hand, no discharge is caused in the discharge cells in which no address discharge and no sustain discharge was caused in the preceding subfield. Thus, the wall charge having been accumulated at the end of the reset period in the preceding subfield is retained without any change.

In the reset period of each subfield, during the time the falling ramp portion S2 or S3 is applied to the scan electrodes, the sustain electrodes are retained at a voltage (potential) Ve (V) and the address electrodes are basically retained the ground voltage 0 V.

As will be described later in detail, however, during the reset period of SF 1, which belongs to the first subfield group, the sustain electrodes may be retained at a voltage (potential) VeH (V). The voltage VeH (V) is higher than the voltage Ve at which the sustain electrodes are retained during the reset period of each of SF 2 and the subsequent SFs, all of which belong to the second subfield group. As described above, the voltage of the sustain electrodes is adjusted during the reset period, so that the amount of charges produced in the individual discharge cells is adjusted. As a result, the luminance of lower gray level SFs produced by an address discharge is appropriately adjusted.

Note that the waveform of a reset pulse is not limited to the one described above. Any wave form may be applicable as long as it causes the voltage difference between the scan and address electrodes to slowly increase or decrease so as to continuously generate a weak discharge.

### Address Period:

In the address period, while the sustain electrodes are retained at a positive voltage, a negative scan pulse (voltage Vad) is applied to the scan electrodes. In addition, a positive address pulse (voltage Vda) is selectively applied to the address electrodes corresponding to the discharge cells to be ON.

At the end of the reset period, a negative wall charge is accumulated at locations closer to the scan electrodes, whereas a positive wall charge is accumulated at locations closer to the address electrodes. In the address period, a voltage is placed on the scan, sustain, and address electrodes in the same polarity as the wall charge accumulated. As a result, an address discharge occurs selectively between the scan and address electrodes. Triggered by this address discharge, an address discharge also starts between the scan and sustain electrodes to accumulate suitable wall charge for the subsequent sustain operation.

In the discharge cells in which an address discharge occurs, negative wall charge is accumulated e on the surface of phosphor layer and also on the surface of the protective layer at locations near the sustain electrodes. In contrast, positive wall charge is accumulated on the surface of the protective layer at locations near the scan electrodes. Upon completion of the address period, all the electrodes are grounded. With this state, a suitable wall voltage for causing a sustain discharge is obtained between the scan and sustain electrodes.

Note that as will be described later in detail, the voltage (potential) VeL of the sustain electrodes in the address period of SF 1, which belongs to the first subfield group, is set to be lower than the voltage (Ve+Ve2) of the sustain electrodes in the address period of SF 2 and of the subsequent SFs, which belong to the second subfield group. With this setting, the extent to which the address discharge generated in the address period of SF 1 spreads is appropriately adjusted for expressing the lowest gray level luminance.

### Sustain Period:

In the sustain period, a sustain pulse of positive polarity (voltage Vsus) is first applied to the scan electrodes, and then sustain pulses of positive polarity are applied alternatively to the sustain and scan electrodes. With the application of sustain pulses, a sustain discharge is generated in the discharge cells having been addressed in the address period, according to the number of sustain pulses applied. In the sustain period of SF2, only one sustain pulse is applied. In the sustain period of SF 3, three sustain pulses are applied. In the sustain period of SF 4 and subsequent SFs, a greater number of sustain pulses are applied.

In SF 3 and subsequent SFs, after the last one of sustain pulses in the sustain period is applied, an erase operation is performed. The erase operation is to extinguish the sustain discharge. In Example 1, the sustain discharge is extinguished by raising the voltage of the scan electrodes and then raising the voltage of the sustain electrodes immediately thereafter. With this erase operation, the amount of wall charge accumulated after the selective reset operation in the subsequent SF is adjusted to be suitable for the subsequent addressing.

Note that the erase operation cannot be performed unless a large amount of wall charge is accumulated during a sustain discharge. Yet, in SF 3, a sufficient amount of wall charge may not be accumulated since the number of sustain pulses applied is relatively small. In view of this, it is desirable in SF 3 to increase the duration of erasing operation as compared with that performed in SF 4 and subsequent SFs to reliably carry out the resetting.

### (Voltage of Sustain Electrodes in Address Period)

According to the drive method of Example 1, the voltage of the sustain electrodes during the address period is made different between the first subfield group (i.e., SF 1) and the second subfield group (i.e., SF 2 and the subsequent SFs). During the address period of SF 1, the sustain electrodes are held at the voltage VeL that is set lower than the voltage (Ve+Ve2) at which the sustain electrodes are held during the address period of SF 2 and the subsequent SFs.

With the above setting of the sustain electrode voltage during the address period, the display capability at lower gray scale levels improves as follows.

As the sustain electrode voltage during the address period is set lower, the spread of address discharge between the scan and sustain electrodes is more restricted.

That is to say, during the address period, negative scan pulses are applied to the scan electrodes and positive address pulses are applied to the address electrodes related to the discharge cells to be ON. As a result, an address discharge occurs between the scan and address electrodes. At this stage, the sustain electrodes are held at positive voltage, so that the address discharge started between the scan and address electrodes spreads to between the scan and sustain electrodes. Naturally, the difference between the voltage of the sustain electrodes and the voltage (potential) Vad of the scan electrodes becomes smaller as the voltage of the sustain electrodes is lower. As a result, the discharge that occurs between the scan and sustain electrodes is weaker and thus the resulting luminance is lower.

In the above manner, the voltage VeL of the sustain electrodes in SF 1 is set relatively lower to restrict the spread to address discharge. As a result, the luminance resulting from the address discharge is reduced to keep the luminance of lower gray levels (Gray Level 1) low. For example, the luminance of a lower gray level (Gray Level 1) may be kept as low as about half the luminance of Gray Level 2 (Feature A).

As described above, SF 1 is controlled to restrict an address discharge (i.e., provided with Feature A), which may lead to insufficient wall charge. Yet, SF 1 is also controlled to apply a positive voltage to the address electrodes during the sustain period (i.e., provided with Feature B), so that a sustain discharge is reliably caused even if the amount of wall charge is small. This will be described later with respect to the sustain period.

In SF 2 and the subsequent SFs, the voltage (Ve+Ve2) of the sustain electrodes is set relatively higher to ensure that an address discharge is caused to spread sufficiently for stable addressing. In SF 2 and the subsequent SFs, the amount of light emitted as a result of address discharge is large. However, this does not affect the display capability at lower gray levels, since SF 2 and the subsequent SFs are subfields for displaying Gray Levels 2 or higher, rather than for the lowest gray level.

As described above, the voltage VeL of the sustain electrodes during the address period of SF 1 is set lower than the voltage (Ve+Ve2) of the sustain electrodes during the address period of SF 2 and the subsequent SFs. With this setting, the display capability at lower gray levels improves.

Note that if the voltage VeL of the sustain electrodes during the address period of SF 1 is set to be equal to the voltage of the sustain electrodes during the sustain period of SF 2 and the subsequent SFs, it is then difficult to suppress the luminance of the lowest gray level (i.e., Gray Level 1) as low as about half the luminance of Gray Level 2. Yet, if the voltage of the sustain electrodes during the address period of SF 1 is set to be equal to the ground voltage, an address discharge generated between the scan and sustain electrodes would not spread, so that a sustain discharge is not generated. As a result, the luminance of the lowest gray level (Gray Level 1) becomes too low.

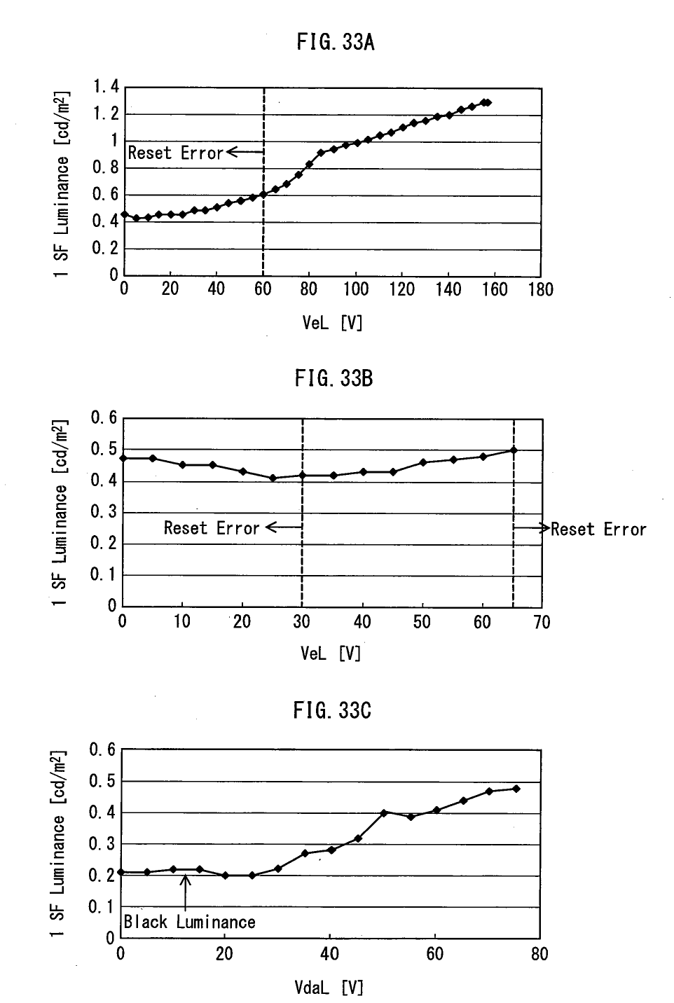

In addition, as in Example 3 shown in FIG. 33A, if the voltage VeL of the sustain electrodes is too low during the address period of SF 1, no sustain discharge is generated, which is likely to cause a reset error. The voltage VeL needs to be set appropriately in view of the above.

In one specific example of such setting, the voltage (Ve+Ve2) of the sustain electrodes is 160 V during the address period of SF 2 and the subsequent SFs, whereas the voltage VeL of the sustain electrodes during the address period of SF 1 is 100 V.

Note that no erase operation is performed in SF 1. Thus, a relatively small amount of wall charge is accumulated after the selective reset operation in the next SF 2. Due to this, horizontal crosstalk (i.e., undesirable leakage of wall charge to adjacent red and blue discharge cells) tends to occur in the green discharge cells during the address discharge in SF 2. Occurrence of horizontal crosstalk subsequently leads to illumination failure of green discharge cells in the next SF 3 (as a result of illumination failure of green discharge cells, magenta is displayed instead of white). Occurrence of horizontal crosstalk is prevented by setting a relatively lower voltage as the voltage Ve at which the sustain electrodes are held during the address period of SF 2. As a result, the spread of the address discharge is restricted to prevent occurrence of horizontal crosstalk. In addition, by extending the duration of the address period of SF 3, an address discharge is stably caused in discharge cells having lost wall charges due to horizontal crosstalk occurred during SF 2.

### (Address Discharge Adjustment by Address and Scan Pulses)

According to the drive method of Example 1, the voltage VeL of the sustain electrodes during the address period of SF 1, which belongs to the first subfield group, is set lower than the voltage (Ve+Ve2) of the sustain electrodes during the address period of SF 2 and the subsequent SFs, which belong to the second subfield group. In addition, the voltage and/or width of address pulse to be applied in the address period may be changed between (i) SF 1 and (ii) SF 2 and the subsequent SFs. Similarly, the voltage of scan pulse to be applied to the scan electrodes during the address period may be changed between (i) SF 1 and (ii) SF 2 and the subsequent SFs.

Note that by setting the address pulse to a lower voltage (potential) or a narrower pulse width, the address discharge becomes increasingly weaker and thus the light emission produced by the address discharge becomes smaller. That is to say, by adjusting the voltage (potential) and/or width of address pulse or the voltage of sustain pulse, the spread of address discharges in SF 1 duly adjusted separately from the spread of address discharges in SF 2 and the subsequent SFs.

The above settings of address and/or scan pulses are therefore effective to adjust the luminance level of SF 1 (i.e., Gray Level 1) without adversely affecting the stable addressing in SF 2 and the subsequent SFs.

The following summarizes how the address discharge is affected by adjusting the voltage of address pulse, the width of address pulse, and/or the voltage of scan pulse.

For the purpose of description, “Vda” denotes the voltage (potential) of, and “Pw” denotes the width of address pulse applied to the address electrodes during the address period of SF 2 and the subsequent SFs. Similarly, “Vad” denotes the voltage of scan pulse applied to the scan electrodes during the address period of SF 2 and the subsequent SFs.

On the other hand, “Vda1” denotes the voltage (potential) and “Pw1” denotes the width of address pulse applied to the address electrodes during the address period of SF 1. Similarly, “Vad1” denotes the voltage of the scan pulses applied to the scan electrodes during the address period of SF 1.

Depending of the settings of the address and/or scan pulses, the strength of the resulting address discharge differs in the following manner.

(1) As the voltage difference (potential difference) of address pulse (i.e., Vda-Vda1) becomes larger, the spread of address discharge in SF 1 is increasingly restricted to reduce the resulting luminance as compared with SF 2 and the subsequent SFs.

(2) As the difference in width of address pulse (Pw-Pw1) becomes larger, the spread of address discharge in SF 1 is increasingly restricted to reduce the resulting luminance as compared with SF 2 and the subsequent SFs.

(3) As the voltage difference of scan pulse (|Vad|-|Vad1|) becomes larger, the spread of address discharge in SF 1 is increasingly restricted to reduce the resulting luminance as compared with SF 2 and the subsequent SFs.

Note that, the settings of all the three items above (i.e., address pulse voltage, address pulse width, and scan pulse voltage) may be made different between the first subfield group (i.e., SF 1) and the second subfield group (i.e., SF 2 and the subsequent SFs). Alternatively, the settings of one or two of the items may be made different.

In one specific example setting of the address pulse width, the address pulse width Pw in SF 2 and the subsequent SFs may be set to fall within a range of normal address pulse width (4.0 to 2.0 μsec or so), so that the resulting address discharge would spread to between the scan and sustain electrodes to reliably perform addressing. In SF 1, on the other hand, the address pulse width Pw1 is set to be narrower than that of SF 2, so that the address pulse ends to extinguish the address discharge before the address discharge spreads to between the scan and sustain electrodes. As a result, the luminance of the lowest gray level (SF 1) is suppressed low. In contrast, if the address pulse width Pw1 in SF 1 is set to be wider than that of the address pulse width of SF 2, the luminance of the lowest gray level (SF 1) increases but a stabile address discharge is ensured.

In the above example, the address and/or scan pulses are adjusted to control the address discharge, in addition to the setting of the voltage VeL of the sustain electrodes during the address period of SF 1 to be lower than the voltage (Ve+Ve2) of the sustain electrodes during the address period of SF 2 and the subsequent SFs. Yet, it is effective to adjust the address and/or scan pulses to improve the display capability at lower gray levels, even if the voltage of the sustain electrodes during the address period is the same between SF 1 and the subsequent SFs.

### (Controlling Address Discharge by Adjusting Amount of Wall Charge During Reset Period)

According to the drive method of Example 1, the address discharge is controlled by setting the voltage VeL of the sustain electrodes during the address period of SF 1 to be lower than the voltage (Ve+Ve2) of the sustain electrodes during the address period of SF 2 and the subsequent SFs. In addition to this, the address discharge may be controlled by adjusting the conditions of the reset period, so that the amount of wall charge accumulated during the reset period of SF 1 is different from that accumulated during the reset period of SF 2 and the subsequent SFs.

Here, the amount of wall charge accumulated by the end of the reset period increases as the value of most negative voltage (potential) Vset21 or Vset2 of the scan electrodes during the reset period is set to be higher or as the value of the voltage of the sustain electrode during the reset period is set to be higher.

With the increase in amount of wall charges accumulated in the reset period, the intensity of address discharge in the subsequent address period increases and thus the luminance of the resulting light emission increase. Note, however, that a large amount of wall charge accumulated in the reset period allows an address discharge to occur even if the addressing source voltage Vda is low. This leads to an effect that the addressing source voltage Vda may be set lower. By lowering the addressing source voltage Vda, the resulting address discharge is made weaker accordingly.

As described above, the spread of address discharge caused in SF 1 can be controlled separately from that in SF 2 and the subsequent SFs, by adjusting the most negative voltages Vset21 and Vset2 of the scan electrodes and/or the voltage of the sustain electrodes during the reset period.

By separately controlling the amount of wall charges accumulated in SF 1 separately from that in SF 2 and the subsequent SFs, the luminance of SF 1 (Gray Level 1) is adjusted to be an appropriate level without adversely affecting the stability of addressing in SF 2 and the subsequent SFs.

The following summarizes how the amount of wall charge accumulated during the reset period is affected by adjusting the electrode voltage during the reset period.

(1) In SF 1, the voltage VeH of the sustain electrodes during the time a falling ramp waveform is applied in the reset period is set to be lower than a corresponding voltage Ve in the reset period of SF 2 and the subsequent SFs.

In the reset period, while the voltage of the sustain electrodes is held at Ve during the time of the falling ramp waveform, the voltage of the scan electrodes is decreased to a negative voltage Vset2. Thus, as the voltage Ve of the sustain electrodes set to be higher, the voltage difference between the sustain and scan electrodes (Ve−|Vad+Vset2|) becomes larger at the end of the reset period, which means that the duration of a ramp discharge is longer. That is, the amount of wall charge accumulated between the scan and sustain electrodes by the end of the reset period of SF 1 increases by keeping the voltage Ve of the sustain electrodes relatively high during the falling ramp waveform. A larger amount of wall charges means that the resulting luminance is higher.

(2) In SF 1, the most negative voltage Vset21 of the scan electrodes during the reset period is set to be higher than that in SF 2 and the subsequent SFs. As a result, the amount of wall charge remaining at the end of reset period increases. In contrast, by setting the most negative voltage Vset21 relatively lower, the amount of wall charge remaining at the end of reset period decreases. A larger amount of wall charges means that the resulting luminance is higher. In the above description, the amount of wall charge to be accumulated in the reset period is adjusted, in addition to the setting of the voltage VeL of the sustain electrodes during the address period of SF 1 to be lower than the voltage (Ve+Ve2) of the sustain electrodes during the address period of SF 2 and the subsequent SFs. Yet, it is effective to adjust the amount of wall charge to be accumulated during the reset period to improve the display capability at lower gray levels, even if the voltage of the sustain electrodes during the address period is the same between SF 1 and the subsequent SFs.

### (Sustain Period)

As shown in FIG. 3, during the sustain period of SF 1, the sustain electrodes are held at the ground voltage (GND) and the scan electrodes are held at a positive voltage (potential) Vpr1. With this state, a positive voltage (Vda or Vda1) is applied to the address electrodes. The magnitude of this voltage preferably falls between 15 V and 150 V both inclusive.

In general, in the case where the address discharge during the address period is weak (i.e., Feature A is provided), the risk of insufficient sustain discharge in the sustain period increases and thus the risk of reset error in the next all-cell reset period increase as well.

According to Example 1, however, a positive voltage (Vda or Vda1) is applied to the address electrodes during the sustain period (i.e., Feature B is provided). The application of positive voltage accelerates electron emission from the surface of the protective layer 18 included in the front panel PA 1 (to be more precise, areas of the protective layer 18 where the sustain electrode 19b are located) toward the address electrodes. Being induced by electrons emitted from the surface of the protective layer 18, a discharge occurs between the scan electrode 19a and the sustain electrode 19b. As a result, even if the address discharge occurs during the address period is relatively weak, a sustain discharge is generated in the sustain period without a long delay, so that wall charge is developed appropriately.

As a consequence, in the next SF 2, the risk of reset error during the time of the voltage raising portion S1 of the all-cell reset period is reduced.

The positive voltage Vpr1 applied to the scan electrodes during the sustain period of SF 1 may be set so as to be (1) substantially equal to the voltage Vsus of sustain pulse or (2) lower than the voltage Vsus of sustain pulse.

With the positive voltage Vpr1 set relatively high as (1) above, a sustain discharge occurs in the discharge cell shaving been addressed, so that the resulting luminance of SF 1 becomes relatively high (1 cd/m² or so). On the other hand, with the positive voltage Vpr1 set relatively low as (2) above, no sustain discharge occurs in the discharge cell shaving been addressed, so that the resulting luminance of SF 1 becomes relatively low (0.5 cd/m² or so). Since no sustain discharge occurs with the setting (2), the risk of reset error increases. Yet, this risk is addressed by further weakening the address discharge than that would occur with the setting (1).

### (Address Discharge Control Based on Image Data Average Pixel Level (APL))

In the above description, nothing is described about adjusting the level of address discharge in SF 1 based on image data. Yet, it is applicable to make appropriate adjustment based on the average luminance level of image data as detected by the APL detection unit 28.

For example, the voltage VeL of the sustain electrodes may be adjusted during the address period of SF 1. To this end, the APL detection unit 28 detects an APL for each frame. In the case where the detected APL value is relatively small, the voltage VeL of the sustain electrodes may be adjusted to be relatively lower in favor of contrast. On the other hand, in the case where the detected APL value is relatively large, the voltage VeL of the sustain electrodes may be adjusted to be relatively high, in favor of the balance of luminance among the respective gray levels.

With the above adjustment, necessary image characteristics are achieved in accordance with the brightness of image.

### (Drive Circuit for Forming Above Drive Waveform)

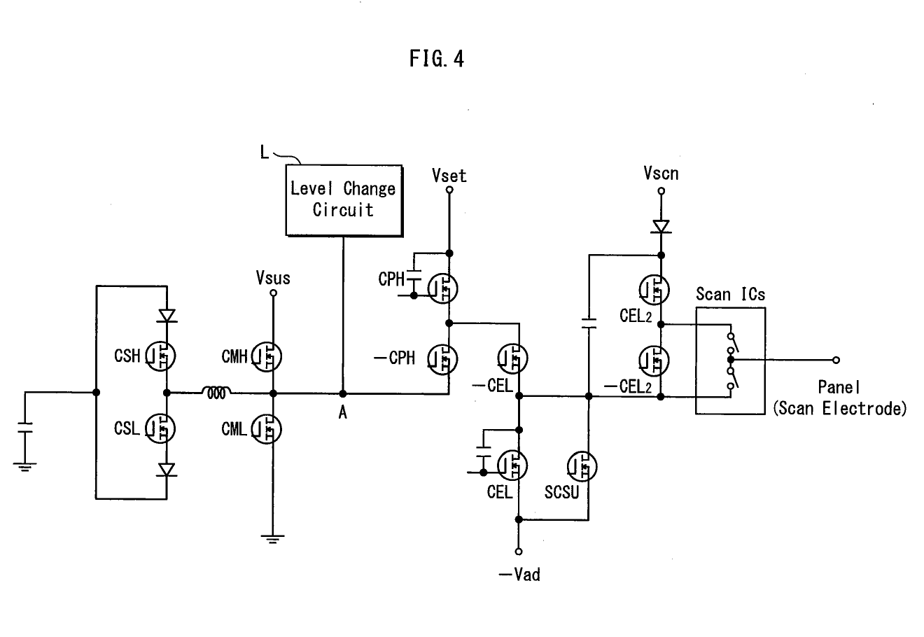

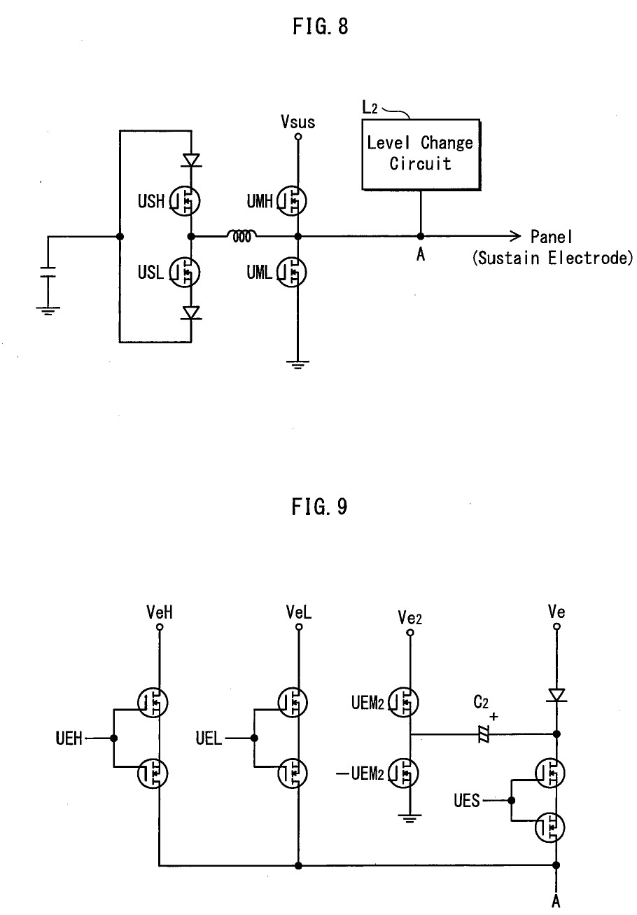

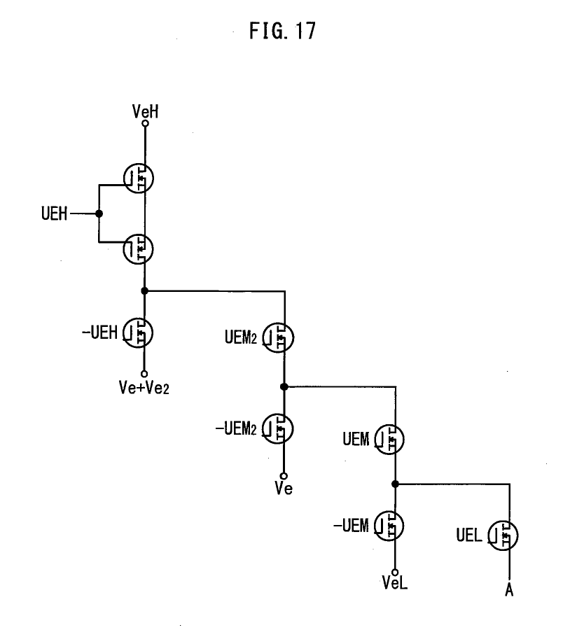

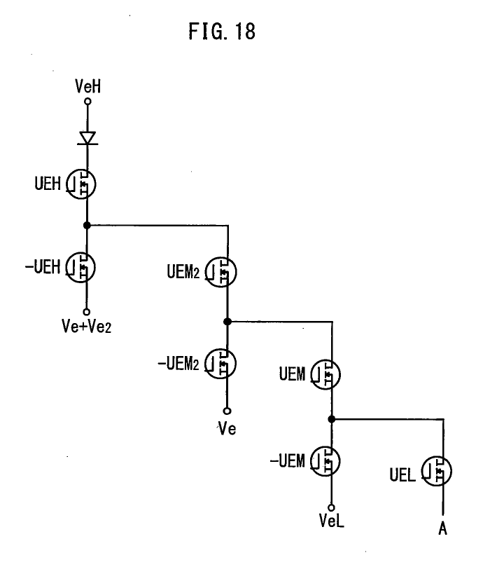

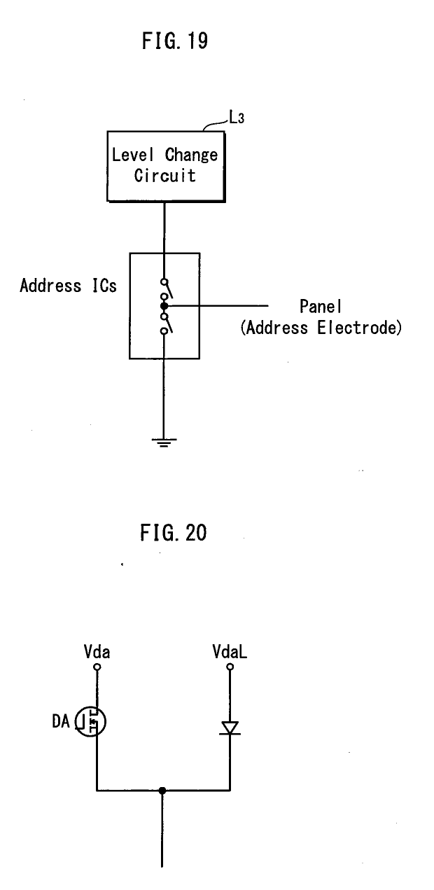

Among the circuits included in the PDP drive circuit shown in FIG. 2, FIGS. 4-7 show the detailed structure of the scan electrode drive circuit 21, FIGS. 8-18 show the detailed structure of the sustain electrode drive circuit 22, and FIGS. 19-21 shown the detailed structure of the address electrode drive circuit 23.

### 1. Scan Electrode Drive Circuit

The scan electrode drive circuit outputs reset pulses (voltage Vset and Vset2), scan pulses (voltage Vad and Vscn), sustain pulses (voltage Vsus), and voltage Vpr1. The following is an exemplary structure of the scan electrode drive circuit.

FIGS. 4-7 show an exemplary scan electrode drive circuit having a level change circuit.

As shown in FIG. 4, the scan electrode drive circuit is provided with the following source voltages: a positive source voltage (Vsus) for sustain pulses, a Hi-side positive source voltage (Vset) for all-cell reset pulses, a Hi-side positive source voltage (Vscn) for addressing and a Lo-side negative source voltage (Vad). Between each pair of a source voltage terminal and an output terminal for output to the scan electrodes SCN, a switching element composed of an FET (field effect transistor) is provided. By controlling the switching elements, the output voltage supplied from the output terminals is controlled.

The circuit shown in FIG. 4 is basically identical to a conventional scan electrode drive circuit, except for the level change circuit L. The scan electrode drive circuit collects reactive power during the sustain period of each subfield SF 1, SF 2, SF 3 . . . , and outputs the voltage waveforms shown in FIG. 3 from the output terminal to the scan electrodes of the PDP. Since the operation of this scan electrode circuit (except for the operation of the level change circuit) is described in detail in PCT application (Application No. PCT/JP02/06180), no further description is given here.

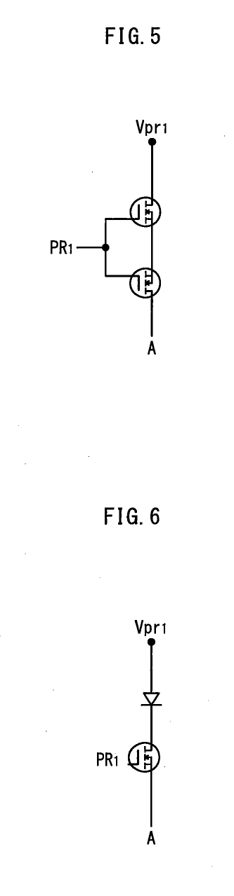

The level change circuit L applies a positive voltage Vpr1 to the scan electrodes during the sustain period of SF 1. FIGS. 5 and 6 each shown an example of the level change circuit L. In both the examples shown in FIGS. 5 and 6, the level change circuit L turns ON/OFF the switching element of the positive voltage Vpr1 to allow/stop the supply of the positive voltage Vpr1 with a fixed voltage to a point A shown in FIG. 4. The ON/OFF of the switching element is controlled by a timing signal PR1 supplied to the gate of the switching element. As is clear from the waveform diagram shown in FIG. 3, the timing signal PR1 is slightly delayed from the start of the sustain period of SF 1. The delay time of the timing signal PR1 from the start of the sustain period is empirically determined.

The PDP determines the start points of the subfields SF 1, SF 2, SF 3 . . . as well as the start points of the reset period, address period, and sustain period in each subfield, all based on the count values of the fast clock counter provided within the timing generation circuit 24. Since the timing signal PR1 should be supplied with a predetermined delay time from the start point of each sustain period, the supply timing is also determined by additionally providing a circuit monitoring the count value of the fast clock counter.

With reference back to the scan electrode drive circuit shown in FIG. 4, the level change circuit L having the structure shown in FIG. 5 or 6 applies a positive voltage Vpr1 to the point A to turn ON the switching elements −CPH and −CEL. As a result, the positive voltage Vpr1 is supplied to the scan electrodes.

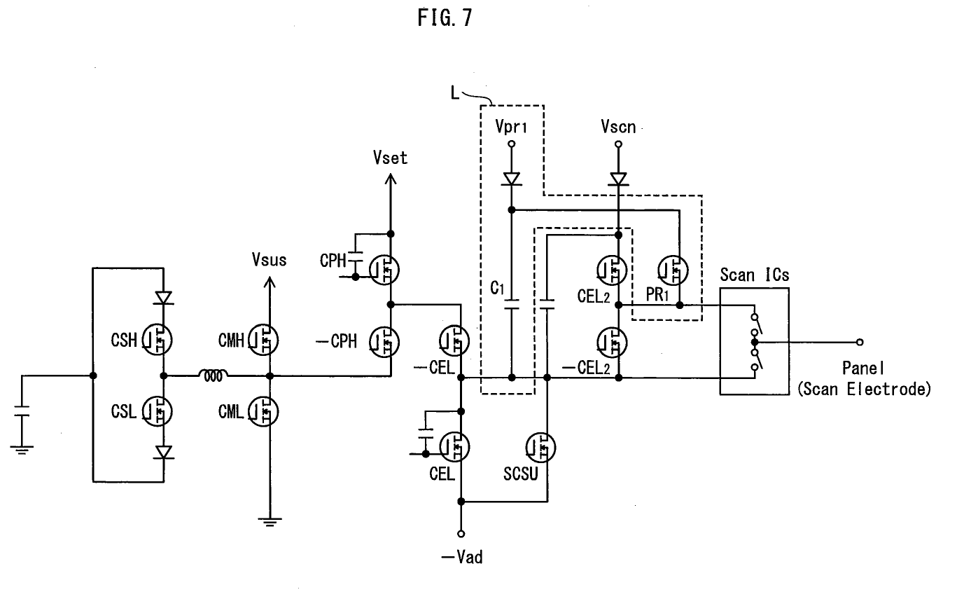

FIG. 7 shows another example of the scan electrode drive circuit. In this example, a portion enclosed in broken lines corresponds to the level change circuit L and the remaining circuitry is substantially identical to that shown in FIG. 4. This level change circuit is a modification of the circuitry shown in FIG. 6 and additionally includes a capacitor C1 for accumulating the voltage of Vpr1.

In accordance with timing signals supplied from the timing generation circuit 24, the scan electrode drive circuit operates in the following manner.

The scan electrode drive circuit applies the rising ramp portion S1 during the reset period, by turning ON the switching elements CPH and −CEL to increase the output voltage to Vset. To apply the falling ramp portions S2 and S3, the scan electrode drive circuit turns ON the switching element CEL to decrease the output voltage to Vad.

During the address period, the scan electrode drive circuit turns ON the switching elements SCSU and CEL2 to control the switching elements of the scan IC group. As a result, the voltage Vscn or voltage Vad is output.

During the sustain period of SF 2 and each of the subsequent subfields, the scan electrode drive circuit turns ON the switching elements −CPH and −CEL to control CMH and CML. As a result, the voltage Vsus or ground voltage is output. At this stage, the switching element −CEL2 may be made ON to protect the scan IC group from overvoltage resulting from noise.

During the sustain period of SF 1, the scan electrode drive circuit turns ON the switching elements −CPH and −CEL to turn ON the switching element PR1 of the level change circuit shown in FIG. 5 or 6. As a result, the voltage Vpr1 is output.

In the case where the most negative voltage Vad of scan pulses may be changed between SF 1 and the subsequent subfields, the source Vad needs to be additionally provided with a circuit for changing voltage.

### 2. Sustain Electrode Drive Circuit

FIG. 8 is a view showing the sustain electrode drive circuit.

The sustain electrode drive circuit outputs the following. In each SF, the voltage Vsus is output during the sustain period. In SF 2 and each subsequent subfield, the voltage Ve is output during the reset period and a voltage Ve2 is output during the address period. In SF the voltage VeL is output during the address period. The sustain electrode drive circuit is provided with a level change circuit L2. Note that the voltage VeH is higher than the voltage VeL, so that the relation VeH>VeL is satisfied.

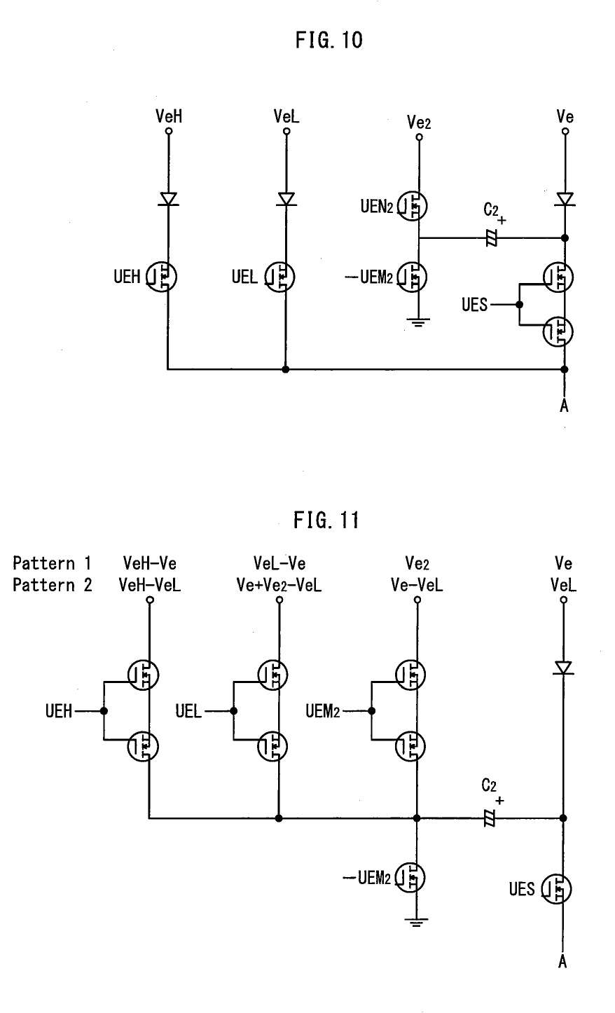

As shown in FIG. 9, the level change circuit L2 has four sources (voltage VeH, VeL, Ve, and Ve2), four switching elements UEH, UEL, UEM2, and UES, and one capacitor C2. The level change circuit L2 appropriately turns ON/OFF the respective switching elements and charge/discharge the capacitor C2 to apply voltage to the sustain electrodes at predetermined timings in appropriate periods. The timings and periods of respective voltage applications are shown in the waveform diagram shown in FIG. 3. That is, voltage VeH is applied during the reset period of SF 1. Voltage VeL is applied in the address period of SF 1. Voltage Ve and voltage (Ve+Ve2) are applied each at a predetermined timing in SF 2 and in the subsequent subfields.

The capacitor C2 is charged to the polarity shown in the figure when the switching element −UEM2 is turned ON. Accordingly, when the switching element UEM2 is later turned ON, the summation of the charging voltage of the capacitor C2 and the voltage Ve2 is output to the point A.

The timing signals for the respective voltages are generated by circuits each monitoring the count value of fast clock counter described above.

FIG. 10 shows a modification of the level change circuit shown in FIG. 9. This modification is made by replacing some of the switching elements with diodes and remains the same in characteristics.

FIG. 11 shows a yet another modification of the level change circuit. This level change circuit is connected so that the charging voltage Ve of the capacitor C2 is added to each of voltage VeH, VeL and Ve2 to output the respective summations. In view of this, each source voltage is set to be equal to the voltage value calculated by subtracting the charging voltage (i.e., VeH−Ve and VeL−Ve). Note that the charging voltage of the capacitor C2 is selectable from voltage Ve and voltage VeL. In FIG. 11, Pattern 1 shows the magnitude of each source voltage in the case where the voltage Ve is selected, whereas Pattern 2 shows the magnitude of each source voltage in the case where the voltage VeL is selected.

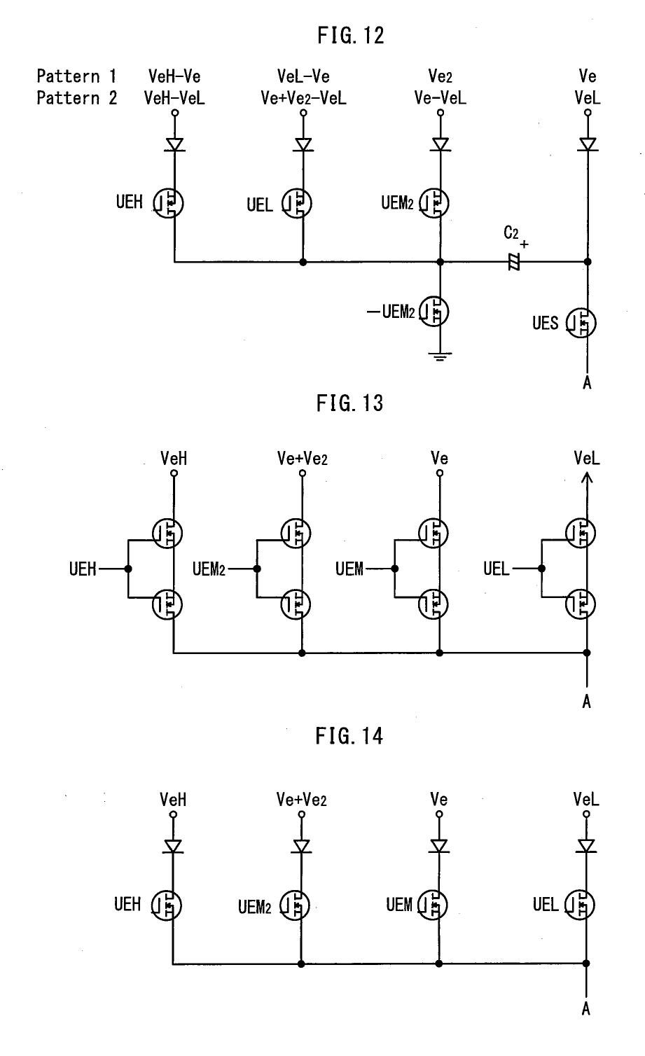

FIG. 12 shows a modification of the level change circuit shown in FIG. 11. This modification is made by replacing some of the switching elements with diodes and remains the same in characteristics.

FIG. 13 shows a yet another modification of the level change circuit. This level change circuit does not include any capacitor C2. The switching elements UEH, UEM2, UEM, and UEL are selectively tuned ON to allow the respective source voltages VeH, Ve+Ve2, Ve, and VeL to be supplied to the point A.

FIG. 14 shows a modification of the level change circuit shown in FIG. 13. This modification is made by replacing some of the switching elements with diodes and remains the same in characteristics.

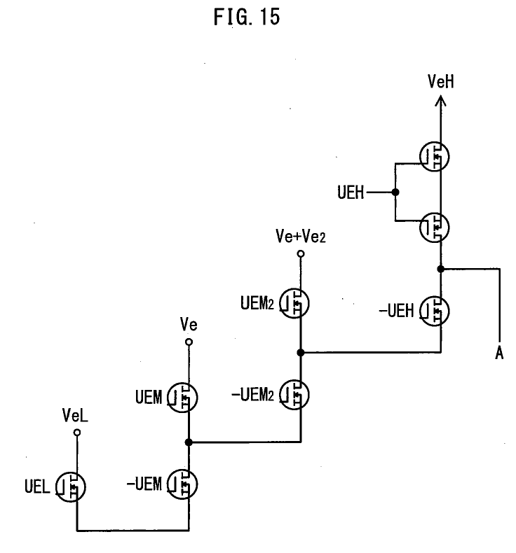

FIG. 15 is a modification of the level change circuit shown in FIG. 14. This level change circuit has a multi-stage circuit connection and includes no capacitors. Unlike the level change circuits shown in up to FIG. 14, the source voltage that is further away from the point A requires a greater number of switching elements to be ON to supply the source voltage to the point A.

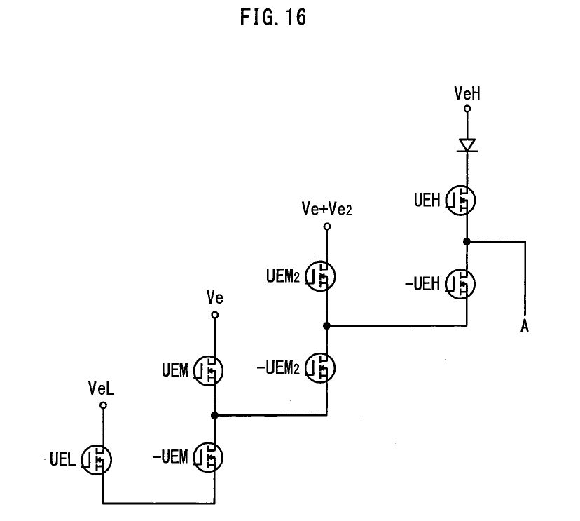

FIGS. 16, 17, and 18 each show a modification of FIG. 15. In each modification, the connection of the switching elements is modified. Yet, the voltage output to the point A remains the same as that shown in FIG. 15.

Note that each level change circuit shown in FIGS. 9-18 is separately provided with the source (VeH) for the reset period of SF 1. Yet, the source (Vsus) for sustain pulses may be used commonly as the source for the reset period of SF 1 to hold the sustain electrodes during the reset period of SF 1 is held at the voltage Vsus. This arrangement makes it possible to omit the source VeH.

Further, the source (VeL) may be omitted, if the voltage of the sustain electrodes during the address period of SF 1 is set to be equal to the voltage Ve of the sustain electrodes during the reset period of SF 2 and the subsequent subfields or equal to the voltage (Ve+Ve2) of the address period of SF 2 and the subsequent subfields.

### 3. Address Electrode Drive Circuit

FIG. 19 is a schematic diagram showing the structure of the address electrode drive circuit. The address electrode drive circuit includes a level change circuit for adjusting the voltage of address pulses to be output in the address period of SF 1, the addressing voltage to be output in the sustain period, and the voltage of address pulses to be output in the address period of SF 2 and the subsequent subfields.

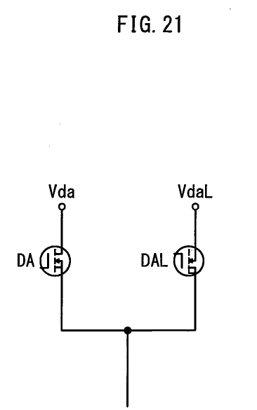

FIGS. 20 and 21 are views each showing an example of the level change circuit included in the address electrode drive circuit shown in FIG. 19.

The level change circuit shown in FIG. 20 includes one diode and one switching element DA. By controlling the switching element DA, the output of the level change circuit is switched between the source voltages Vda and VdaL.

The magnitude of each voltage satisfies the relation of VdaL<Vda. The level change circuit is configured to output the source voltage Vda when the switching element DA is ON.

The level change circuit shown in FIG. 21 includes two switching elements DA and DAL. By switching ON/OFF of the switching elements DA and DAL, the output of the level change circuit is switched between the source voltages Vda and VdaL.

The switching elements DA and DAL are controlled at appropriate timings, so that voltage to the address IC group is supplied from the positive source voltage VdaL during the address period of SF 1 and from the positive source voltage Vda during the address period of SF 2 and the subsequent subfields.

As a result of the above control, the address IC group outputs address pulses at the source voltage VdaL during the address period of SF 1 and outputs address pulses at the source voltage Vda during the address period of SF 2 and the subsequent subfields.

Further, the address electrode drive circuit may control the switching elements DA and DAL during the sustain period of SF 1 to switch the output between the source voltage Vda and the source voltage VdaL.

### (Grouping of First and Second Subfield Groups)

Up to this point, the description has been given to the case where the first subfield group is composed solely of SF 1 and the second subfield group is composed of SF 2 and the subfields subsequent to SF2. Alternatively, however, the plurality of subfields of one TV field may be grouped into the first and second subfield groups in the following manner. That is, the first subfield group is composed of SF 1 and at least one more subfields selected from SF 2, SF 3, and SF 4, whereas the second subfield group is composed of the reset of the subfields. Even with such grouping, the above aspects of the present invention can be duly embodied in the following manner. That is, during the address period of each SF belonging to the first subfield group, the voltage VeL of the sustain electrodes may be held lower than the voltage (Ve+Ve2) of the sustain electrodes during the address period of each SF belonging to the second subfield group. Optionally, the voltage and/or width of address pulse applied to the address electrodes during the address period may be made different between the first and second subfield groups. Optionally, the voltage of scan pulse applied to the scan electrodes during the address period may be made different between the first and second subfield groups.

In one example, the first subfield group is composed of SF 1, SF 2, and SF 3, whereas the second subfield group is composed of SF 4, SF 5, SF 6 . . . . In this example, the voltage VeL at which the sustain electrodes are held during the address period of SF 1, SF 2, and SF 3, which belong to the first subfield group, is set to be lower than the voltage (Ve+Ve2) at which the sustain electrodes are held during the address period of SF 4, SF 5, SF 6 . . . , which belong to the second subfield. Optionally, the voltage and/or width of address pulse applied to the address electrodes during the address period may be made different between the first subfield group (SF 1, SF 2, and SF 3) and the second subfield group (SF 4,SF 5,SF 6 . . . ). Similarly, the voltage of scan pulse applied to the scan electrodes may be made different between the first subfield group (SF 1, SF 2, and SF 3) and the second subfield group (SF 4,SF 5,SF 6 . . . ).

### Example 2

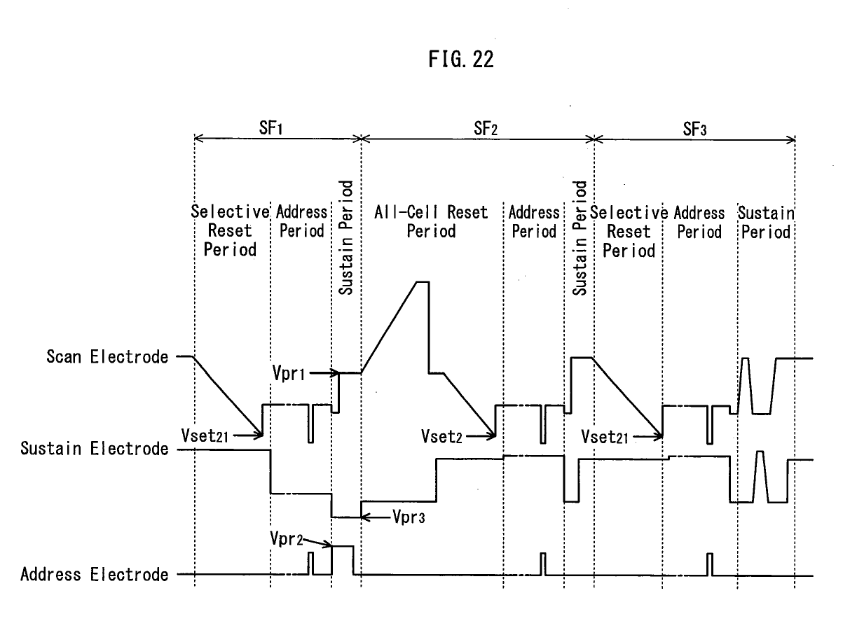

FIG. 22 is a view showing drive voltage waveforms applied by the respective drive circuits of Example 2 to the corresponding electrodes of the PDP in each subfield.

The drive method according to Example 2 is identical to Example 1 both in drive waveform and operation, except for those related to the sustain period of SF 1. Example 2 is similar to Example 1 in the following respect. That is, in the sustain period of SF 1, a positive voltage is applied to the address electrodes and then the positive voltage Vpr1 is applied to the scan electrodes to generate a sustain discharge in the discharge cells, so that occurrence of reset error is suppressed. According to Example 2, however, a voltage (potential) Vpr2 at which the address electrodes are held during the sustain period of SF 1 is set higher than the voltage (Vda and VdaL) of address pulse applied during the address period.

In Example 1, the sustain electrodes are held at the ground voltage during the sustain period SF 1. According to Example 2, however, the sustain electrodes during that time is held at a negative voltage (potential) Vpr3.

As described above, the sustain electrodes are held at a negative voltage during the sustain period of SF 1. Yet, since a positive voltage is applied to the address electrodes, a weak address discharge is sufficient to cause a sustain discharge.

In addition, during the sustain period of SF 1, the address electrodes are held at the voltage Vpr2 which is higher than the voltage of address pulse applied to the address electrodes during the address period. This arrangement also ensures that a weak address discharge is sufficient to cause a sustain discharge.

In addition, the voltage of the negative voltage of the sustain electrodes as well as of the voltage Vpr2 of the address electrodes are both increased. With this arrangement, a weak discharge is generated in the discharge cells not addressed in SF 1 besides the addressed discharge cells, which serves to suppress occurrence of reset error.

In general, high-definition PDPs and PDPs with a discharge gas having high Xe partial pressure (for example, Xe content of 65%) involve a higher risk of reset error. According to Example 2, however, a weak discharge is generated also in the non-addressed discharge cells, so that the risk of reset error is eliminated by virtue of priming effect.

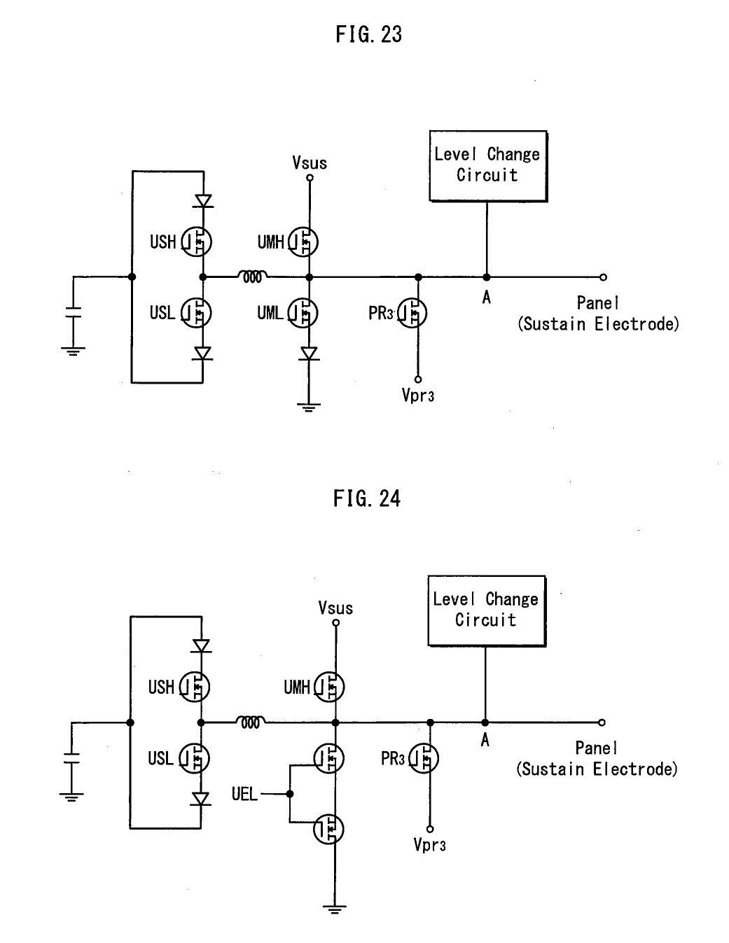

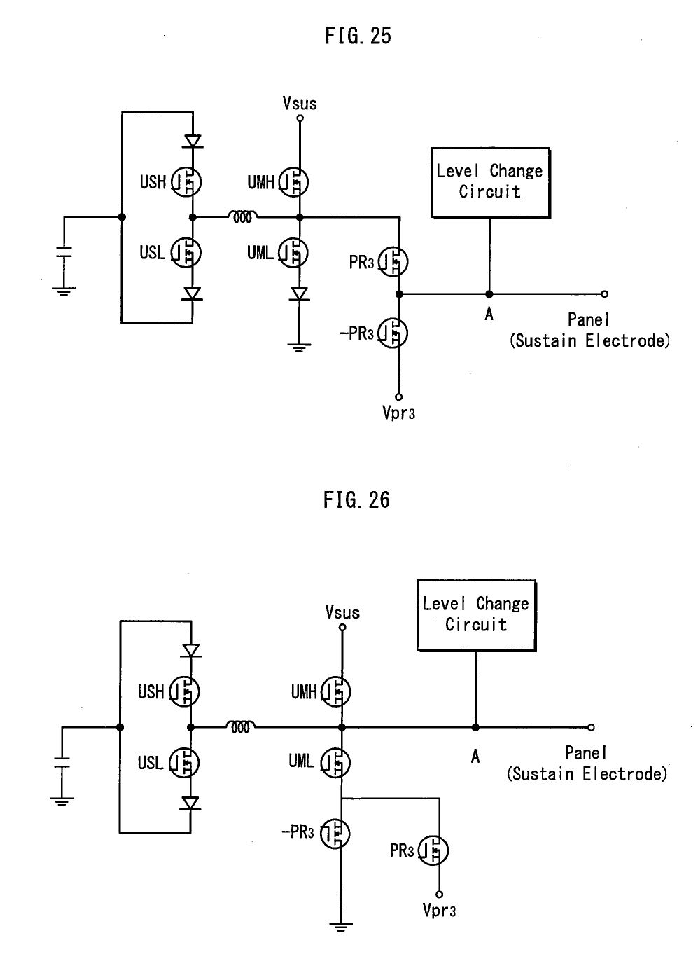

FIGS. 23-26 are views each showing a structure of the sustain electrode drive circuit according to Example 2.

Each sustain electrode drive circuit is identical to the sustain electrode drive circuit of Example 1, except that a negative source voltage Vpr3 and a switching element PR3 are additionally provided.

Each sustain electrode drive circuit operates in a similar manner to the sustain electrode drive circuit of Example 1 during the sustain, reset, and address periods. However, in the sustain period of SF 1, each sustain electrode drive circuit of Example 2 controls the switching element PR3, so that the output is made from the source voltage Vpr3 during that period.

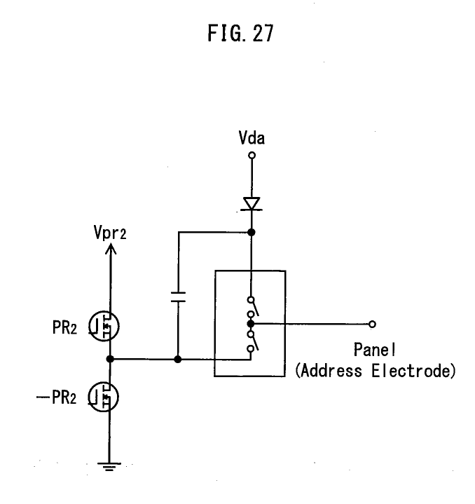

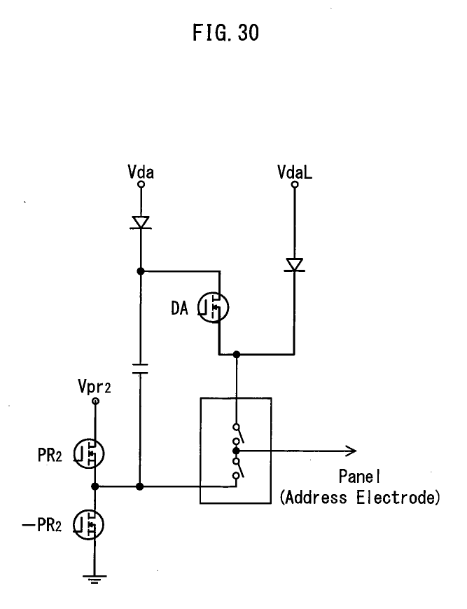

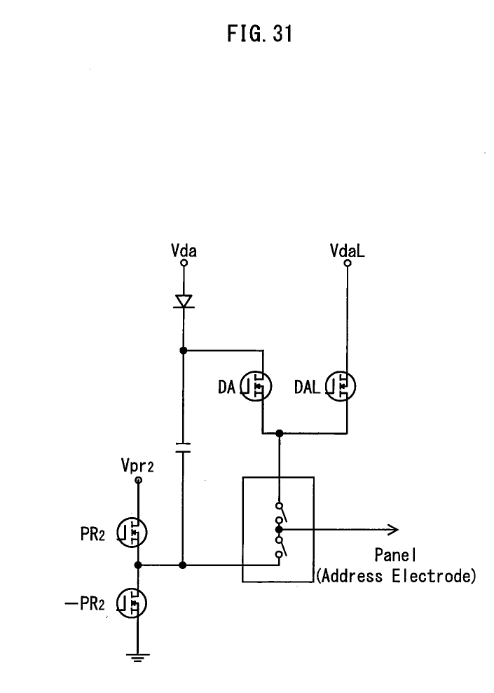

FIGS. 27-31 are views each showing a structure of the address electrode drive circuit according to Example 2.

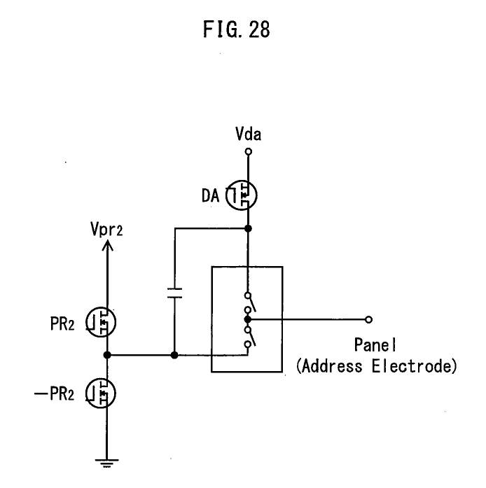

Each address electrode drive circuit shown in FIGS. 27 and 28 includes source voltages Vda and Vpr2, switching elements PR2 and −PR2 for controlling the output of voltage Vpr2, and one of a diode and a switching element DA for controlling the output of the source voltage Vda.

By controlling the switching element DA, the address electrode drive circuit applies the source voltage Vda to address IC group during each address period, so that address pulses of the source voltage Vda are output. In addition, during the sustain period of SF 1, the address electrode drive circuit outputs the voltage Vpr2.

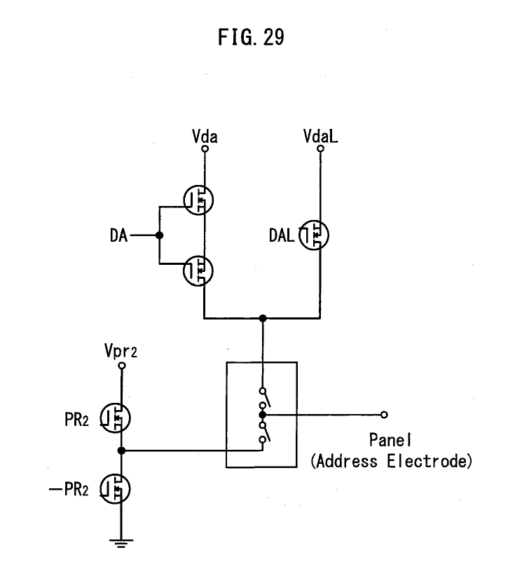

Each address electrode drive circuit shown in FIGS. 29, 30, and 31 includes a source voltage VdaL and a source voltage Vda and also includes switching elements DA and DAL for controlling the output of the respective source voltages. The switching elements DA and DAL may be replaced with diodes.

In addition, the address electrode drive circuit includes a source voltage Vpr2 and switching elements PR2 and −PR2 for controlling the output of the source voltage.

By controlling the respective switching elements, the address electrode drive circuit applies the source voltage VdaL to the address IC group during the address period of SF 1 to output address pulses of the source voltage VdaL are output. During each address period of SF 2 and the subsequent subfields, the address electrode drive circuit applies the source voltage Vda to the address IC group to output address pulses of the source voltage Vda.

In addition, each address electrode drive circuit outputs the voltage Vpr2 in the sustain period of SF 1.

### Example 3

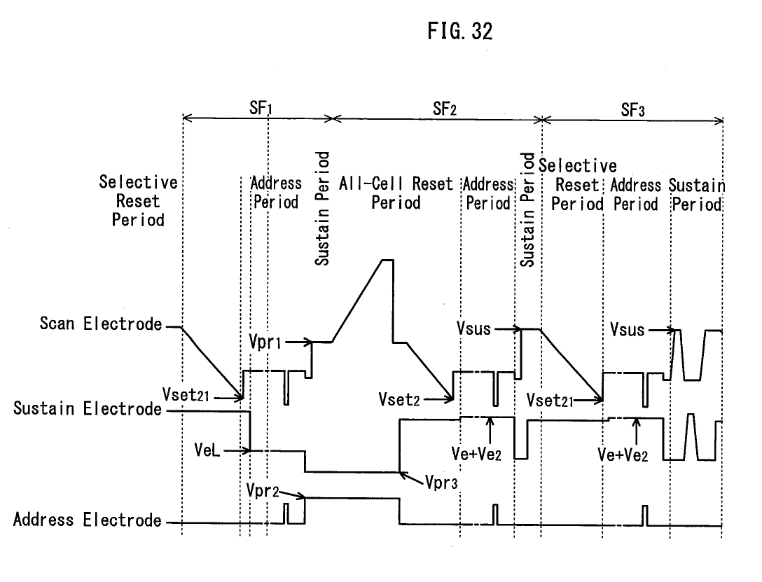

FIG. 32 is a view showing drive voltage waveforms applied by the respective drive circuits of Example 3 to the corresponding electrodes of the PDP in each subfield.

The drive method according to Example 3 is identical to Example 2, except for the following respect. In Example 2, the address electrodes are held at the ground voltage GND during the all-cell reset period. According to the Example 3, however, the address electrodes are continually held at the voltage Vpr2, which is positive voltage, during the rising ramp portion of the all-cell reset period of SF 2 subsequent to the sustain period of SF 1 (that is, Example 3 is provided with Feature C in addition to Feature B). In addition, during the rising ramp portion, the sustain electrodes are held at the negative voltage Vpr3.

As described above, the address electrodes are held at a positive voltage during the time the rising ramp portion is applied in the all-cell reset period (Feature C is provided). As a consequence, the voltage across the scan and address electrodes is reduced, which is effective to reduce the risk of reset error in the all-cell reset period.

The following describes the effect produced by Feature C to reducing the risk of reset error.

In general PDPs, a reset error occurs often as a result that no sustain discharge occurs in addressed discharge cells. In such a case, during the time the rising ramp portion S1 is applied in the subsequent all-cell reset period, a weak discharge tends to be unstable, which often leads to a reset error. In addition, it is known that a weak discharge starting between the scan and address electrodes during the rising ramp portion S1 in the all-cell reset period often results in a reset error.

In view of the above risk, according to Example 3, the address electrodes are held at a positive voltage during the rising ramp portion applied in the all-cell reset period as shown FIG. 32. With this arrangement, the voltage across the scan and address electrodes is made smaller than otherwise it would be, so that a weak discharge does not start between the scan and address electrodes.

In addition, during the time of rising ramp portion in the all-cell reset period, the sustain electrodes are held negative, so that the voltage across the scan and sustain electrodes is made larger than otherwise it would be. This ensures that a weak discharge starts between the scan and sustain electrodes.

As a consequence, Example 3 is effective to reduce occurrence of reset error in the all-cell reset period.

According to the drive method of Example 3, the following experiment was conducted. In the experiment, a PDP with the Xe content of 6% was used and the respective voltages were set as follows: Vset=230 V, Vad=90 V, Vset2=5 V, Vscn=130 V, Vsus=180 V, Ve=155V, Ve2=5 V, and Vda=75 V. Note in addition, that although the experiment was conducted by using the PDP with the Xe content ratio of 6%, in the case of a high-definition PDP or a PDP with a higher partial pressure of Xe in the discharge gas (for example, content ratio of 65%), each voltage should be about 1 to 2 times higher.

(1) The PDP was driven in the following manner. During the sustain period of SF 1, the scan electrodes were held at the voltage Vpr1 that was equal to the voltage Vsus of the sustain pulses (Vpr1=Vsus), the address electrodes were held at the voltage Vpr2 that was equal to the source voltage Vda of the address pulses (Vpr2=Vda), and the sustain electrodes were held at the voltage Vpr3 that was equal to the ground voltage (Vpr3=GND). Then, the voltage VeL of the sustain electrodes were varied within the range of 0 to 160V during the address period of SF 1 to observe the emission luminance of SF 1.

FIG. 33A is a graph showing the measurement results. As is clear from the figure, the emission luminance varied within the range of 0.4 to 1.3 cd/m². The emission luminance of SF 1 decreased with the decrease of the voltage Vpr1. Note that the luminance of SF 2 was 1.6 cd/m².

In addition, with the voltage VeL set to less than 60 V, are set error was observed. Yet, even with the voltage VeL set to less than 60 V, it was effective to bring the voltage Vpr3 of the sustain electrodes to a negative voltage in order to reduce the occurrences of reset error.

(2) During the sustain period of SF 1, the scan electrodes were held at the voltage Vpr1 that was equal to the voltage Vscn of the scan pulses (Vpr1=Vscn), the address electrodes were held at the voltage Vpr2 that was equal to the source voltage Vda of the address pulses (Vpr2=Vda), and the sustain electrodes were held at the voltage Vpr3 that was equal to the ground voltage (Vpr3=GND). Then, the voltage VeL of the sustain electrodes were varied within the range of 0 to 70V during the address period of SF 1 to observe the emission luminance of SF 1.

FIG. 33B is a graph showing the measurement results. As is clear from the figure, the emission luminance varied within the range of 0.4 to 0.5 cd/m². The emission luminance of SF 1 slightly decreased with the decrease of the voltage Vpr1, as long as the voltage VeL was within the range of 30 to 65 V.

In addition, with the voltage VeL set to less than 30 V or to exceed 65 V, occurrence reset error was observed. Yet, even with the voltage VeL set to less than 30 V, it was effective to bring the voltage Vpr3 of the sustain electrodes to a negative voltage in order to reduce the occurrence of reset error. Similarly, even with the voltage VeL exceeding 65 V, it was effective to bring the voltage Vpr3 of the sustain electrodes to a positive voltage in order to reduce the occurrence of reset error.

(3) During the sustain period of SF 1, the scan electrodes were brought to the voltage Vpr1 that was equal to the voltage Vscn of the scan pulses (Vpr1=Vscn), the address electrodes were brought to the voltage Vpr2 that was equal to the voltage Vda of the address pulses (Vpr2=Vda), and the sustain electrodes were brought to the voltage Vpr3 that was equal to the ground voltage (Vpr3=GND). Then, the voltage VeL of the sustain electrodes was fixed to 65 V, and the source voltage VdaL of address pulse was varied within the range of 0 to 75 V during the address period of SF 1 to observe the emission luminance of SF 1.

FIG. 33C is a graph showing the measurement results. As is clear from the figure, the emission luminance varied within the range of 0.2 to 0.5 cd/m². The emission luminance of SF 1 slightly decreased with the decrease of the voltage VdaL, as long as the voltage VdaL was within the range of 30 to 75 V. Note that the upper limit of 75 V is determined due to the withstanding voltage of the address IC group. Thus, if the withstanding voltage of the address IC group is higher, 75 V or higher would fall within the range.

Note that Vpr2 set to 15 V or higher is effective to reduce occurrence of reset errors. However, Vpr2 set to 150 V or higher increases the risk of discharge occurring between the address and sustain electrodes. In view of this, it is desirable to set Vpr2 to 150 V or less. Here, in order to simplify the circuitry, Vpr2 is set to be equal to Vda. Further, Vpr3 set to the ground voltage or lower is effective to reduce occurrence of reset errors. Here, in order to simplify the circuitry, Vpr3 is set to be equal to the ground voltage.

The above experimental results show that by adjusting the voltage VeL of the sustain electrodes and/or the source voltage VdaL of address pulses during the address period SF 1, the luminance of Gray Level 1 is finely adjusted. Thus, the luminance of SF 1 is suitably adjusted to be about half the luminance of SF 2.

According to Example 3, the voltage of the scan electrodes is raised sharply from the ground voltage to the voltage Vpr1 (i.e., at the voltage gradient 100 V/μs or more) in the sustain period of SF 1. With this waveform, the duration of the sustain period can be made relatively short. Alternatively, however, the voltage of the scan electrodes may be up-ramping as shown in Example 4 below.

### Example 4

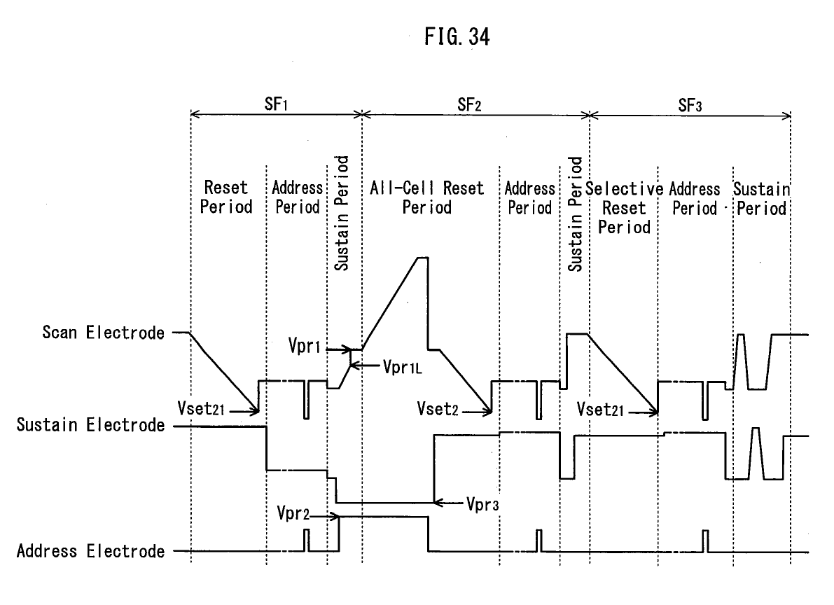

FIG. 34 is a view showing drive voltage waveforms applied by the respective drive circuits of Example 4 to the corresponding electrodes of the PDP in each subfield.

The drive method according to Example 4 is identical to Example 3 both in drive waveform and operation, except for the following respect. In Example 4, the voltage of the scan electrodes during the sustain period of SF 1 has a ramp portion that rises from the ground voltage to a voltage (potential) Vpr1L (i.e., the voltage changes gently at the voltage gradient 10 V/μs or less) and is subsequently pulled up to the voltage Vpr1. Note that the voltage Vpr1L is at a voltage that does not trigger a sustain discharge.

Compared with the case where the voltage of the scan electrodes is raised gradually, the voltage that is raised sharply all at once generates a greater sustain discharge so that the resulting emission intensity is higher.

That is, in Example 4, the voltage of the scan electrodes is first raised slowly from the ground voltage to Vpr1L and then pulled up to the voltage Vpr1 during the sustain period of SF 1. With this arrangement, although the sustain period needs to be increased in duration, the emission intensity of the resulting sustain discharge is decreased to achieve an adequate level of luminance of SF 1 of a low gray level (i.e., Gray Level 1). Note that a similar effect is achieved by causing a weak discharge at about when the voltage Vpr1L reaches its peak.

### Example 5

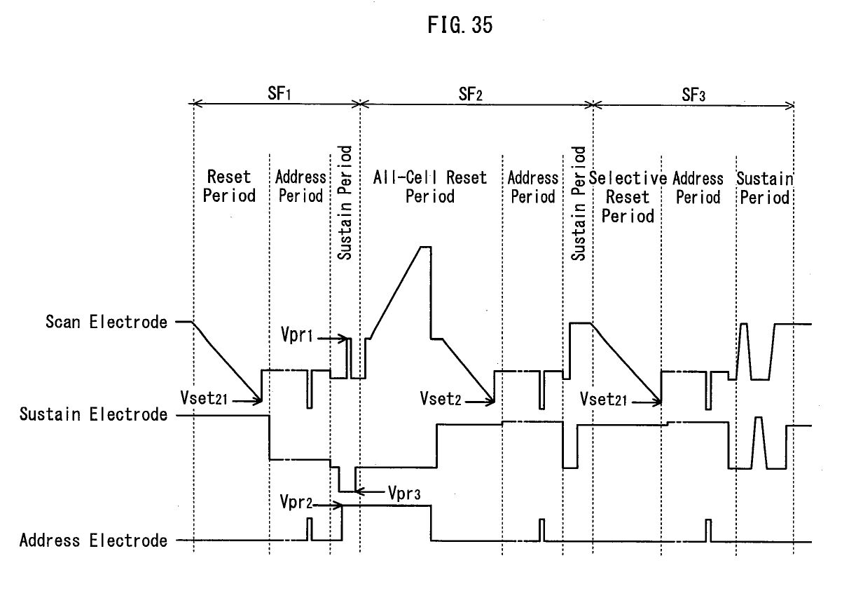

FIG. 35 is a view showing drive voltage waveforms applied by the respective drive circuits of Example 5 to the corresponding electrodes of the PDP in each subfield.

The drive method according to Example 5 is identical to that of Example 4, except for the following respect. In Example 4, the voltage of the scan electrodes is raised to the voltage Vpr1 in the sustain period of SF 1 and continuously retained at that voltage during the subsequent all-cell reset period of SF 2. According to Example 5, however, the voltage of the scan electrodes is once raised to the voltage Vpr1 and immediately decreased to the ground voltage within the sustain period of SF 1. Thereafter, the voltage of the scan electrodes is raised again in SF 2.

Comparison between the cases where the scan electrodes are held at the voltage Vpr1 during the sustain period of SF 1 relatively longer and shorter, it is shown that the resulting sustain discharge is greater with the duration of Vpr1. As a result, the emission intensity increases, so that the amount of wall charge in the selective reset period of the subsequent SF decrease, which increase the risk of horizontal crosstalk at the time of address discharge in SF 2.

That is, in Example 5, the voltage of the scan electrodes during the sustain period of SF 1 is raised to Vpr1 and immediately decreased to GND to define a pulsed waveform to shorten the duration during which Vpr1 is retained. This arrangement serves to produce an erasing effect of erasing the sustain discharge before it ends. As a result, the resulting emission intensity is decreased, which in turn decrease the risk of horizontal crosstalk during the address discharge in SF 2.

Consequently, the emission intensity resulting from the sustain discharge is decreased to achieve an adequate level of luminance of SF 1 of the lower gray level (i.e., Gray Level 1). In addition, the risk of horizontal crosstalk during the address discharge in SF 2 is reduced.

### Example 6

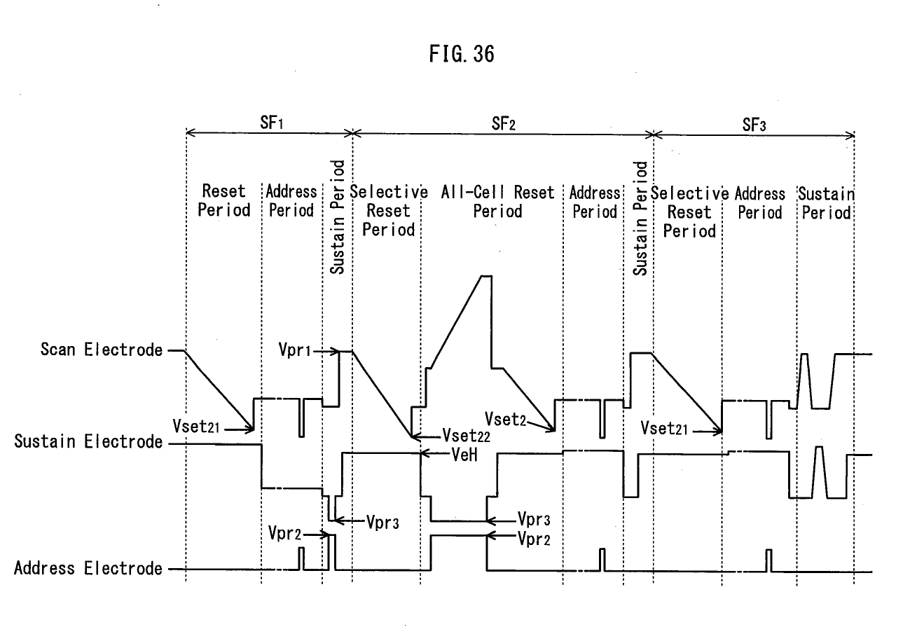

FIG. 36 is a view showing drive voltage waveforms applied by the respective drive circuits to the corresponding electrodes of the PDP in SF 1 and SF 2.

In Examples 1-5 described above, the sustain period of SF 1 is followed by the all-cell reset period of SF 2 (see FIG. 32 for reference). According to Example 6, however, the sustain period of SF 1 is followed by the selective reset period of SF 2 and subsequently followed by the all-cell reset period of SF 2.

The drive method of Example 6 achieves the same operation and effect as that achieved by each Example 1-5 and implements the all-cell reset discharge operation with a higher stability.

To be more specific, in Examples 1-5, the all-cell reset period is immediately subsequent to the sustain period of SF 1. In this case, at the time when an all-cell reset discharge is generated in the all-cell reset discharge period, the discharge cells in which an address discharge is generated in SF 1 retains wall charge accumulated as a result of the sustain discharge. On the other hand, those discharge cells in which no address discharge is caused in SF 1 retains wall charge accumulated as a result of an all-cell reset or a selective reset in the preceding TV field.

That is, at the start of SF 2, the state of wall discharge differs depending on whether an address discharge is generated or not generated in SF 1. Naturally, the level of weak discharge generated in the all-cell reset period differs.

In addition, through a sustain discharge generated in the sustain period of SF 1, negative charges are accumulated on the scan electrodes, whereas positive charges are accumulated on the sustain electrodes. Because of this, an all-cell reset discharge may not be generated in all the discharge cells during the time the voltage raising portion is applied in the all-cell reset period of SF 2. A failure to cause an all-cell reset discharge increases the risk of illumination failure in green discharge cells due to horizontal crosstalk in SF 3. In the event of a green color defect, magenta undesirably appears instead of white in images displayed on the PDP.

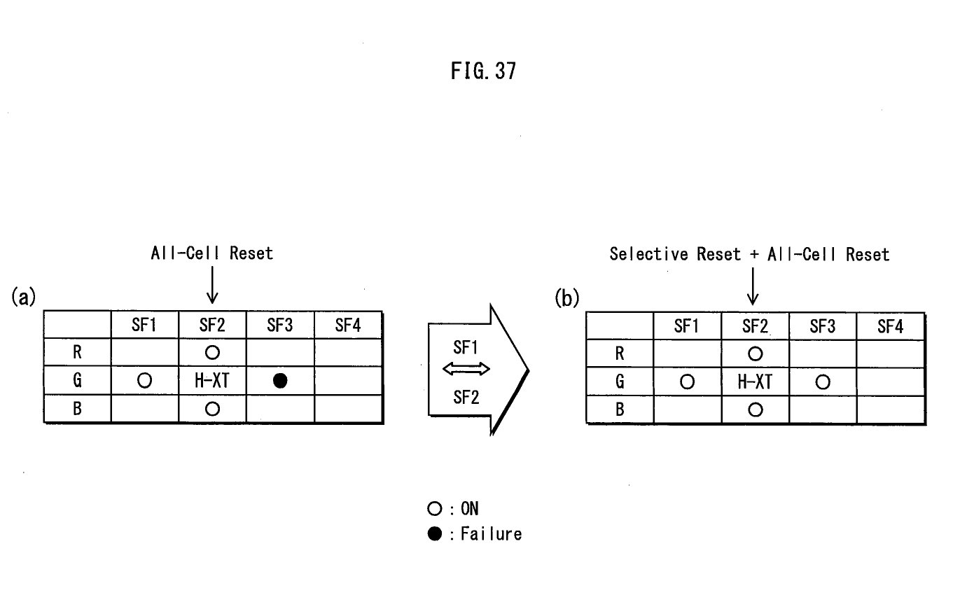

FIG. 37 shows tables illustrating occurrence of horizontal crosstalk in relation to occurrence of illumination failure. Table A shows Examples 1-5 (in which the period that is immediately subsequent to the sustain period of SF 1 is not a selective reset period). Table B shows Example 6 (in which the period that is immediately subsequent to the sustain period of SF 1 is a selective reset period).

Comparison is made between Tables A and B with respect to occurrence of a color defect in SF 3.

Both in Tables A and B, a sustain discharge duly occurs in the green discharge cells in SF 1 during which no erase operation is performed. In SF 2, however, no sustain discharge is generated in the green discharge cells, while a sustain discharge is generated in the red and blue discharge cells. As a result, during the address period of SF 2, horizontal crosstalk (a phenomenon in which wall charges are leaked from the green discharge cells to adjacent red or blue discharge cells) occurs in the green discharge cells.

As shown in Table A, since the selective reset operation is not performed immediately after the sustain period of SF 1, an all-cell reset discharge is not generated sufficiently. As a result, sufficient amount of wall charges may not be accumulated, which increase the risk of horizontal crosstalk and thus increase the risk of illumination failure in green discharge cells. In contrast, as shown in Table B, the selective reset operation is performed immediately after the sustain period, so that a sufficient all-cell reset discharge is generated to supplement wall charges. As a result, the risk of horizontal crosstalk is reduced, so that the risk of illumination failure in green discharge cells is reduced as well.

In view of the above problem, according to Example 6, a selective reset operation is performed immediately after the sustain period of SF 1 to prevent occurrence of addressing error.

Note that in Example 6, it is effective to increase the voltage difference (Vset22 and VeH) between the respective three electrodes (i.e., the scan, sustain, and address electrodes) in the selective reset period of SF 2. With this arrangement, the states of wall charges in the discharge cells are made even more uniform regardless of whether or not an address discharge is generated in SF 1.

In addition, it is also effective to apply a positive voltage Vpr2 to the address electrodes during the selective reset period of SF 2 to intentionally cause a weak discharge between the address and scan electrodes. As a result, negative charges are accumulated on the address electrodes. This arrangement allows to reduce the voltage Vset applied to the scan electrodes in the all-cell reset period.

In addition, it is also effective to employ the following subfield ON/OFF patterns in order to prevent occurrence of a color defect due to illumination failure. In one of the desirable patterns, a sustain discharge is not generated in SF 1, if followed by SF 2 in which no sustain discharge is generated and subsequently followed by SF 3 in which a sustain discharge is generated. In one of the desirable patterns, if a sustain discharge is generated in SF 1, such SF 1 is always followed by SF 2 and the subsequent subfields which are continually stayed ON.

### Example 7

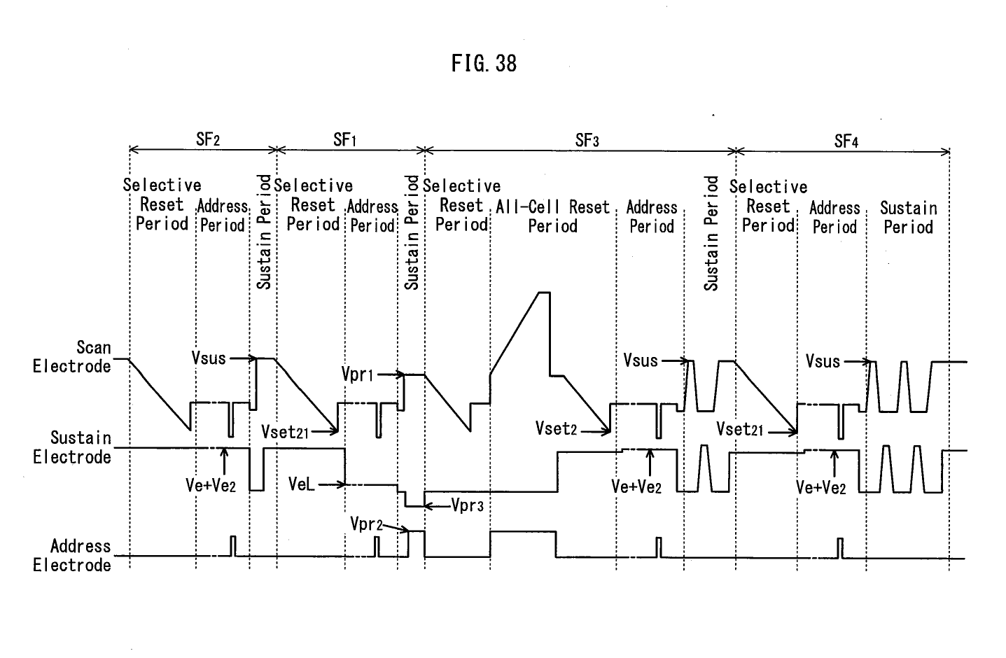

FIG. 38 is a view showing drive voltage waveforms applied by the respective drive circuits of Example 7 to the corresponding electrodes of the PDP in each subfield.

In Example 6, the means for reducing occurrence horizontal crosstalk is provided within SF 1. In Example 7, however, occurrence of horizontal crosstalk is reduced by arranging the order of SF 2 in all the subfields of one TV fields.

In each Example 1-6, the first one of the subfields in the entire TV field is SF 1 that corresponds to Gray Level 1, and the next subfield is SF 2 that corresponds to Gray Level 2. According to Example 7, however, the order of SF 1 and SF 2 is reversed. That is, the first one of the subfields is SF 2 that corresponds to Gray Level 2 and the next subfield is SF 1 that corresponds to Gray Level 1.

In accordance with the change of the order, the subfield in which an all-cell reset period is provided is changed. That is, in Examples 1-6, an all-cell reset operation is performed in SF 2. In Example 7, however, an all-cell reset operation is performed in SF 3.

That is, in Example 7, SF 2 that is disposed first in the entire TV field is the subfield having the smallest luminance weight among all the subfields in which no adjustment is made on the luminance resulting from an address discharge. In addition, SF 1 that is next to SF 2 is a subfield in which the luminance resulting from an address discharge is adjusted. In SF 3 that follows SF 2 has a reset period in which an all-cell reset operation is performed by applying a waveform that includes a rising ramp portion to raise the voltage of the scan electrodes.

Examples 1-6 involve the risk of horizontal crosstalk in SF 4 (the second subfield from SF 2), which leads to the risk of illumination failure in green discharge cells. In the event of a green color defect, magenta undesirably appears instead of white in images displayed on the PDP. However, Example 7 achieves to reduce the risk of green color defect as described below.

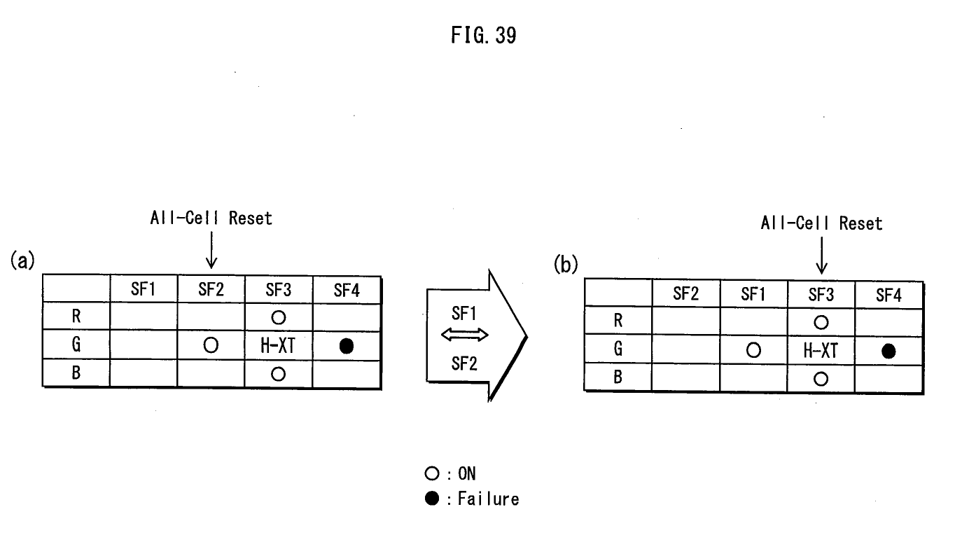

FIG. 39 shows tables illustrating occurrence of horizontal crosstalk in relation to occurrence of illumination failure. Table A shows Examples 1-6 (in which the order of SF 1 and SF 2 is not reversed). Table B shows Example 7 (in which the order of SF 1 and SF 2 is reversed).

Comparison is made between Tables A and B with respect to occurrence of a color defect in SF 3 and SF 4 (i.e., the second subfield from SF 2). As is clear from Table A, during SF 2 in which no erase operation is performed, a sustain discharge is duly generated in the green discharge cells. However, in SF 3, no sustain discharge is generated in the green discharge cells while a sustain discharge is generated in the red and blue discharge cells. As a consequence, during the address period of SF 3, horizontal crosstalk (a phenomenon in which wall charges are leaked from the green discharge cells to adjacent red or blue discharge cells) occurs in the green discharge cells. Also, as is clear from Table B, in SF 2 in which no erase operation is performed, a sustain discharge is duly generated in green discharge cells. However, in SF 1, no sustain discharge is generated in green discharge cells while a sustain discharge is generated in red and blue discharge cells. As a consequence, during the address period of SF 1, horizontal crosstalk occurs in green discharge cells.

Up to this point, Tables A and B are similar in that horizontal crosstalk occurs in both the drive methods. However, according to the drive method shown in Table A, an all-cell reset operation is not performed in the next SF 3, so that an illumination failure occurs in the green discharge cells. However, according to the drive method shown in Table B, an all-cell reset operation is performed in the next SF 3, so that a sufficient amount of wall charges are accumulated in the green discharge cells to supplement the loss caused by horizontal crosstalk. With the sufficient wall charges, an illumination failure in the green discharge cells is prevented.

As described above, in Example 7, the order of SF 1 and SF 2 is reversed. With this arrangement, the risk of illumination failure in green discharge cells during SF 3 is further reduced as compared with Examples 1-6.

Note that the color defect due to the above illumination failure is prevented also by setting the width of address pulse wider. In Examples 1-6 above, the width of address pulse applied in SF 4 may be set wider, which leads to an effect of preventing occurrence of a color defect.

Further, in FIG. 38 only one sustain pulse is applied in SF 2 that is disposed first in the entire TV field. Alternatively, however, three sustain pulses (equal to the number of sustain pulses applied in SF 3) may be applied in SF 2.

### Example 8

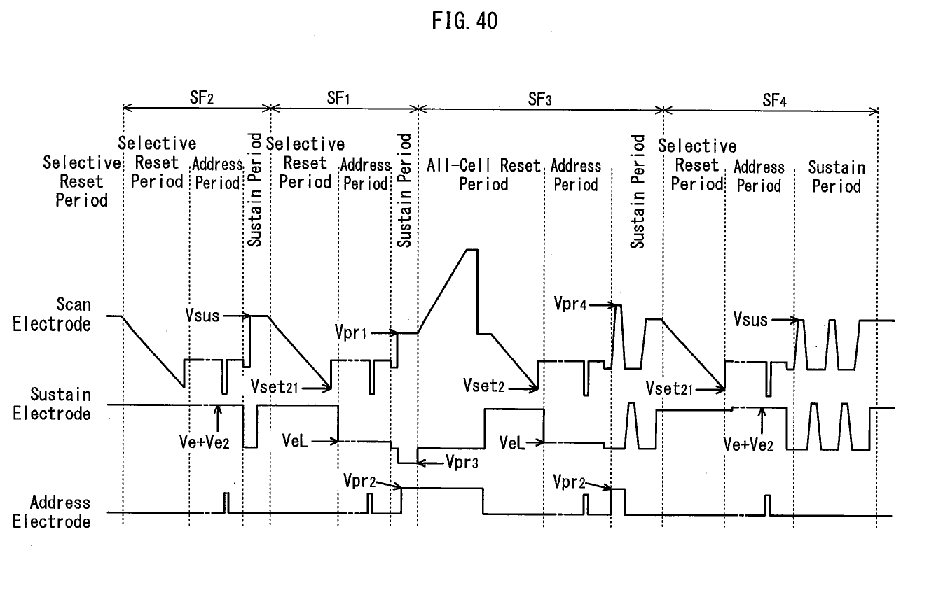

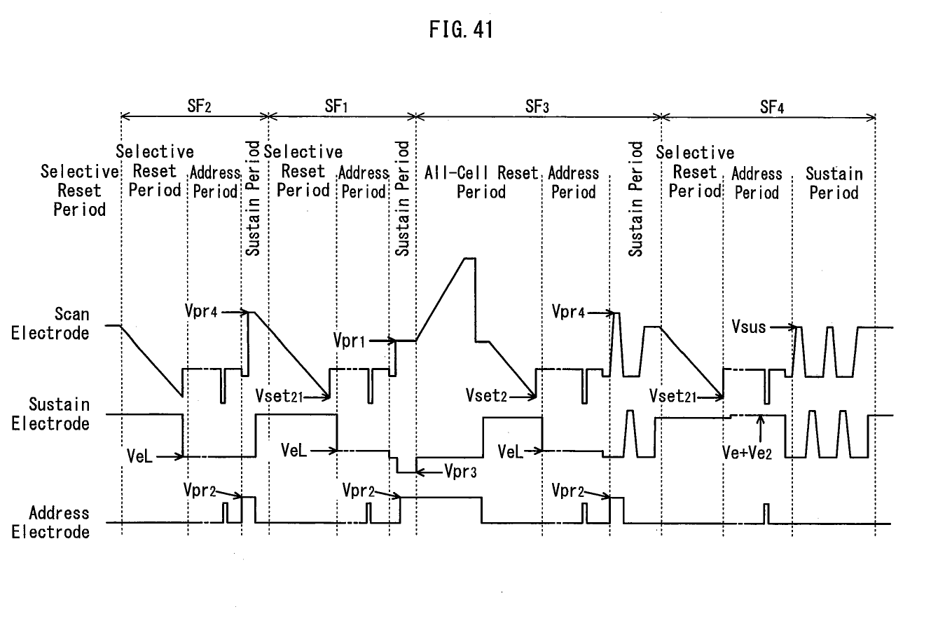

FIG. 40 is a view showing drive voltage waveforms applied by the respective drive circuits of Example 8 to the corresponding electrodes of the PDP in each subfield.

The drive method of Example 8 is identical to that of Example 7, except for the following respect. According to Example 7, in the address period that is subsequent to the all-cell reset period SF 3, the sustain electrodes is raised to the voltage (Ve+Ve2). According to Example 8, however, in the address period of SF 3, the sustain electrodes are raised to the voltage VeL which is relatively lower. In addition, during the sustain period of SF 3, a positive pulse (voltage Vpr2) is applied to the address electrodes.

As shown in FIG. 40, the drive method of Example 8 applies a positive pulse (voltage Vpr2) to the address electrodes only during the time a sustain pulse is applied to the scan electrodes. Yet, the duration of positive pulse may be made longer and the width of the pulse duration may be determined empirically.

As has been described in relation to Example 7, horizontal crosstalk is likely to occur during the address period of SF 3 in those green discharge cells in which a sustain discharge is caused in SF 1. According to Example 8, however, the voltage to which the sustain electrodes are raised in SF 3 is set to the voltage VeL, which is relatively lower. Thus, an address discharge occurring in SF 3 is set to be weak.

By reducing the strength of address discharge occurring in SF 3, the risk of horizontal crosstalk is reduced, so that the risk of color defect in SF 4 due to illumination failure is further reduced.

It should be noted here that it is generally true that reduction of the strength of address discharge occurring in SF 3 decreases the reliability of occurrence of sustain discharge, which increases the risk of illumination failure. According to Example 8, however, a positive pulse is applied to the address electrodes during the sustain period of SF 3, as described above. With the application of a positive pulse, occurrence of an illumination failure due to failure of sustain discharge is suppressed.

In FIG. 40, the voltage Vpr4 of the first sustain pulse applied during the stain period of SF 3 is at least 2 V higher than the voltage VSUS of sustain pulses applied during the sustain period of SF 4 and the subsequent subfields. Setting the voltage Vpr4 of sustain pulses relatively higher is also effective to suppress occurrence of illumination failure due to failure of sustain discharge during the sustain period.

Note that as in Example 8, by setting the voltage of the sustain electrodes during the address period to be relatively lower, occurrence of horizontal crosstalk is prevented. Such a drive method is effective not only to improve the image quality at low gray levels but also to prevent the occurrence of horizontal crosstalk in a PDP having a high Xe content or a high-definition PDP.

It is inherent to the first address period after an all-cell reset operation that an address discharge tends to be relatively strong, so that horizontal crosstalk is caused. This tendency is more not able especially in PDPs having a high Xe content or in high-definition PDPs. In view of this, by setting a relatively lower voltage as the voltage of the sustain electrodes in the first address period after an all-cell reset operation, occurrence of horizontal crosstalk is effectively prevented.

### Example 9

FIG. 41 is a view showing drive voltage waveforms applied by the respective drive circuits of Example 9 to the corresponding electrodes of the PDP in each subfield.

The drive method according to Example 9 is identical to that of Example 8, except for the following respect. That is, not only in SF 3 but also in SF 2, the voltage of the sustain electrodes during the address period is set to the voltage VeL, which is relatively low. In addition, a positive pulse (voltage Vpr2) is applied to the address electrodes.

As described above, additionally in SF 2, the voltage of the sustain electrodes is set to the voltage VeL, which is relatively low. As a result, the resulting address discharge is weaker than otherwise it would be, so that the luminance of SF 2 is appropriately adjusted to a low level.

It is effective to adjust the luminance of SF 2 as descried above in order to achieve a sufficient balance between the respective luminance levels of SF 1, SF 2, and SF 3.

It is noted that a weak address discharge in SF 2 tends to reduce the reliability of occurrence of sustain discharge and thus the risk of discharge failure increase. According to Example 9, however, a positive pulse is applied to the address electrodes during the sustain period of SF 2 as described above. With the application of a positive pulse, occurrence of an illumination failure due to failure of sustain discharge is suppressed.

In addition, according to the drive method shown in FIG. 41, the voltage Vpr4 of the first one of sustain pulses applied during the sustain period of SF 3 is at least 2 V higher than the voltage VSUS of sustain pulse applied during the sustain period of SF 4 and the subsequent subfields. Setting the voltage Vpr4 of sustain pulse relatively higher is also effective to suppress occurrence of illumination failure due to failure of sustain discharge during the sustain period.

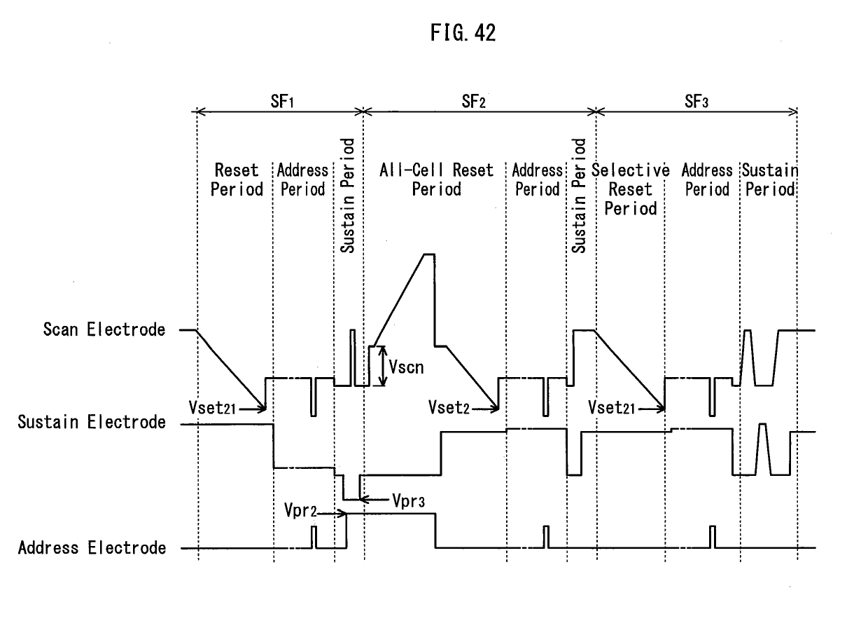

Note in Examples 1-9, the voltage Vset of the sustain pulses applied during the all-cell reset period of SF 2 is raised with the use of the voltage (Vsus or Vpr1). Alternatively, however, the voltage Vset used in the all-cell reset period of SF 2 may be raised with the use of the voltage Vscn of scan pulse. That is, as shown in FIG. 42, the voltage of scan pulse is divided between the sustain period and the all-cell reset period of SF 2. Then, the voltage Vset is pulled up by the voltage Vscn. This arrangement allows to reduce the number of switching elements used in the scan electrode drive circuit.

### INDUSTRIAL APPLICABILITY

Generally, PDP devices are said to be inferior to CRT devices in display capability at lower gray scale levels. The present invention improves the display capability of PDP devices at lower gray scale levels and thus useful to improve the image quality of PDP devices.

1. A plasma display panel drive method for driving a plasma display panel that includes: a first substrate having disposed thereon display electrodes including scan and sustain electrodes; a second substrate (i) having address electrodes disposed thereon and (ii) arranged in spaced face-to-face relation to the first substrate, with the address electrodes oriented to extend in a direction intersecting the display electrodes; and a plurality of discharge cells formed between the two substrates, wherein
one TV field is composed of a plurality of subfields each having: a reset period of generating a reset discharge to reset the discharge cells; an address period of generating an address discharge in discharge cells selected to be ON; and a sustain period of generating a sustain discharge in the addressed discharge cells,
the plurality of subfields are divided into: a first group that includes a subfield with a smallest luminance weight; and a second group that includes all other subfields not belonging to the first group,
in each second group subfield, the sustain electrodes are held at a first voltage of positive polarity during the address period, and
in one or more first group subfields including the subfield with the smallest luminous weight, (i) the sustain electrodes are held at a second voltage during the address period, the second voltage being higher than a ground voltage and lower than the first voltage and (ii) a positive voltage is applied to the address electrodes during a time when a sustain discharge is generated.

2. A plasma display panel drive method for driving a plasma display panel that includes: a first substrate having disposed thereon display electrodes including scan and sustain electrodes; a second substrate (i) having address electrodes disposed thereon and (ii) arranged in spaced face-to-face relation to the first substrate, with the address electrodes oriented to extend in a direction intersecting the display electrodes; and a plurality of discharge cells formed between the two substrates, wherein
one TV field is composed of a plurality of subfields each having: a reset period of generating a reset discharge to reset the discharge cells; an address period of generating an address discharge in discharge cells selected to be ON; and a sustain period of generating a sustain discharge in the addressed discharge cells,
the plurality of subfields are divided into: a first subfield group that includes a subfield with a smallest luminance weight; and a second subfield group that includes all other subfields not belonging to the first subfield group,
at least one of the subfields has, in the reset period, an all-cell reset period having a voltage rising period during which a voltage of the scan electrodes ramps up at a voltage gradient of 10 V/μs or less,
in each second group subfield, the sustain electrodes are held at a first voltage of positive polarity during the address period,
in one or more first group subfields including the subfield with the smallest luminous weight, the sustain electrodes are held at a second voltage during the address period, the second voltage being higher than a ground voltage and lower than the first voltage, and
during at least part of the all-cell reset period, a positive voltage is applied to the address electrodes.

3. The plasma display panel drive method according to claim 2, wherein
in said one or more first group subfields including the subfield with the smallest luminous weight, a positive voltage is applied to the address electrodes during a time when a sustain discharge is generated.

4. (canceled)

5. The plasma display panel drive method according to claim 2, wherein
in the voltage rising period of the all-cell reset period, a negative voltage is applied to the sustain electrodes.

6. The plasma display panel drive method according to claim 2, wherein
a voltage applied to the address electrodes in the voltage rising period of the all-cell reset period is made higher than a voltage applied to the address electrodes in the address period.

7. The plasma display panel drive method according to claim 2, wherein
the reset period of a subfield subsequent to the subfield with the smallest luminance weight is the all-cell reset period.

8. The plasma display panel drive method according to claim 2, wherein
a subfield subsequent to the subfield with the smallest luminance weight has, in the reset period, a selective reset period having a voltage decreasing period during which a voltage of the scan electrodes ramps down at a voltage gradient of 10 V/μs or less, and
the all-cell reset period is subsequent to the selective reset period.

9. The plasma display panel drive method according to claim 2, wherein
an average luminance level of image data is detected per TV field, and a magnitude of the second voltage is adjusted based on the detected average luminance level.

10. The plasma display panel drive method according to claim 2, wherein
a voltage applied to the scan electrodes during a sustain discharge in the sustain period is made different between (i) said one or more first group subfields including the subfield with the smallest luminous weight and (ii) the second group subfields.

11. The plasma display panel drive method according to claim 2, wherein
at least either of a voltage and width of address pulse applied to the address electrodes in the address period is made different between (i) at least one of the first group subfield with the smallest luminance weight and (ii) each second group subfield.

12. The plasma display panel drive method according to claim 2, wherein
a voltage of a scan pulse applied to the scan electrodes in the address period is made different between (i) at least one of the first group subfield with the smallest luminance weight and (ii) each second group subfield.

13. The plasma display panel drive method according to claim 2, wherein
a most negative voltage of the scan electrodes during the reset period is made different between (i) at least one of the first group subfield with the smallest luminance weight and (ii) each second group subfield.

14. The plasma display panel drive method according to claim 2, wherein
a voltage of the sustain electrodes in the reset period is made different between (i) at least one of the first group subfield with the smallest luminance weight and (ii) each second group subfield.

15. The plasma display panel drive method according to claim 2, wherein
in said one or more first group subfields including the subfield with the smallest luminous weight, a negative voltage is applied to the sustain electrodes in the sustain period.

16. The plasma display panel drive method according to claim 2, wherein
in said one or more first group subfields including the subfield with the smallest luminous weight, a voltage applied to the address electrodes is made higher in the sustain period than in the address period.

17. The plasma display panel drive method according to claim 2, wherein
in each first group subfield, a voltage of only a first one of sustain pulses applied to the scan electrodes during the sustain period is raised.

18. The plasma display panel drive method according to claim 2, wherein
in the first group subfield with the smallest luminance weight, a waveform applied to the scan electrodes in the sustain period includes a rising ramp portion that is followed by a steeply rising portion.

19. The plasma display panel drive method according to claim 2, wherein
in the first group subfield with the smallest luminance weight, a waveform applied to the scan electrodes in the sustain period includes a single pulsed portion that raises and then decreases a voltage of the scan electrodes.

20. The plasma display panel drive method according to claim 2, wherein
a last one of sustain pulses applied during the sustain period is controlled to end relatively later in a subfield with a smaller luminance weight among the first group subfields than in a subfield with a larger luminance weight.

21. The plasma display panel drive method according to claim 2, wherein
in a subfield subsequent to one of the first group subfields with a second smallest luminance weight, a most negative voltage during the reset period is set higher than a most negative voltage during the reset period of each of the other first group subfields.

22. The plasma display panel drive method according to claim 2, wherein
the plasma display panel is driven so that none of the discharge cells follows an ON-OFF pattern in which the discharge cell is turned ON in the subfield with the smallest luminance weight, turned OFF in an immediately subsequent subfield, and subsequently turned ON.

23. A plasma display device comprising:
a plasma display panel including:
a first substrate having disposed thereon display electrodes including scan and sustain electrodes;
a second substrate (i) having address electrodes disposed thereon and (ii) arranged in spaced face-to-face relation to the first substrate, with the address electrodes oriented to extend in a direction intersecting the display electrodes; and
a plurality of discharge cells formed between the two substrates; and
a drive unit operable to drive the plasma display panel to display an image, by a method according to which one TV field is composed of a plurality of subfields each having a reset period, an address period, and a sustain period, wherein
the plurality of subfields are divided into: a first group that includes a subfield with a smallest luminance weight; and a second group that includes all other subfields not belonging to the first group, and
the drive unit is operable to:
hold, in each second group subfield, the sustain electrodes at a first voltage of positive polarity during the address period;
hold, in one or more first group subfields including the subfield with the smallest luminous weight, the sustain electrodes at a second voltage during the address period, the second voltage being higher than a ground voltage and lower than the first voltage; and
apply, in one or more first group subfields including the subfield with the smallest luminous weight, a positive voltage to the address electrodes during a time when a sustain discharge is generated.

24. A plasma display device comprising:
a plasma display panel including:
a first substrate having disposed thereon display electrodes including scan and sustain electrodes;
a second substrate (i) having address electrodes disposed thereon and (ii) arranged in spaced face-to-face relation to the first substrate, with the address electrodes oriented to extend in a direction intersecting the display electrodes; and
a plurality of discharge cells formed between the two substrates; and
a drive unit operable to drive the plasma display panel to display an image, by a method according to which one TV field is composed of a plurality of subfields each having a reset period, an address period, and a sustain period, wherein
the plurality of subfields are divided into: a first group that includes a subfield with a smallest luminance weight; and a second group that includes all other subfields not belonging to the first group,
at least one of the subfields has, in the reset period, an all-cell reset period having a voltage rising period during which a voltage of the scan electrodes ramps up at a voltage gradient of 10 V/μs or less, and
the drive unit is operable to:
hold, in each second group subfield, the sustain electrodes at a first voltage of positive polarity during the address period;
hold, in one or more first group subfields including the subfield with the smallest luminous weight, the sustain electrodes at a second voltage during the address period, the second voltage being higher than a ground voltage and lower than the first voltage; and
apply, during at least part of the all-cell reset period, a positive voltage to the address electrodes.

25. The plasma display device according to claim 24, wherein
the drive unit is operable to apply, in said one or more first group subfields including the subfield with the smallest luminous weight, a positive voltage to the address electrodes during a time when a sustain discharge is generated.

26. (canceled)

27. The plasma display device according to claim 24, wherein
the drive unit is operable to apply, in the voltage rising period of the all-cell reset period, a negative voltage to the sustain electrodes.

28. The plasma display device according to claim 24, wherein
the drive unit is operable to apply a voltage to the address electrodes in the voltage rising period of the all-cell reset period, the voltage applied being set higher than a voltage applied to the address electrodes in the address period.

29. The plasma display device according to claim 24, wherein
the reset period of a subfield subsequent to the subfield with the smallest luminance weight is the all-cell reset period.

30. The plasma display device according to claim 24, wherein
a subfield subsequent to the subfield with the smallest luminance weight has, in the reset period, a selective reset period having a voltage decreasing period during which a voltage of the scan electrodes ramps down at a voltage gradient of 10 V/μs or less, and
the all-cell reset period is subsequent to the selective reset period.

31. The plasma display device according to claim 24, wherein
the drive unit is operable to detect an average luminance level of image data per TV field, and to adjust a magnitude of the second voltage based on the detected average luminance level.

32. The plasma display device according to claim 24, wherein
the drive unit is operable to apply a voltage applied to the scan electrodes during a sustain discharge in the sustain period, the voltage applied being made different between (i) said one or more first group subfields including the subfield with the smallest luminous weight and (ii) the second group subfields.

33. The plasma display device according to claim 24, wherein
the drive unit is operable to apply an address pulse to the address electrodes in the address period, at least either of a voltage and width of the address pulse applied being made different between (i) at least one of the first group subfield with the smallest luminance weight and (ii) each second group subfield.

34. The plasma display device according to claim 24, wherein
the drive unit is operable to apply a scan pulse to the scan electrodes in the address period, a voltage of the scan pulse applied being made different between (i) at least one of the first group subfield with the smallest luminance weight and (ii) each second group subfield.

35. The plasma display device according to claim 24, wherein
the drive unit is operable to change, between (i) at least one of the first group subfield with the smallest luminance weight and (ii) each second group subfield, a most negative voltage of the scan electrodes during the reset period.

36. The plasma display device according to claim 24, wherein
the drive unit is operable to change, between (i) at least one of the first group subfield with the smallest luminance weight and (ii) each second group subfield, a voltage of the sustain electrodes in the reset period.

37. The plasma display device according to claim 24, wherein
the drive unit is operable to apply, in said one or more first group subfields including the subfield with the smallest luminous weight, a negative voltage to the sustain electrodes in the sustain period.

38. The plasma display device according to claim 24, wherein
the drive unit is operable to apply, in said one or more first group subfields including the subfield with the smallest luminous weight, a voltage to the address electrodes, the voltage applied being set higher in the sustain period than in the address period.

39. The plasma display device according to claim 24, wherein
the drive unit is operable to raise, in each first group subfield, a voltage of only a first one of sustain pulses applied to the scan electrodes during the sustain period.

40. The plasma display device according to claim 24, wherein
the drive unit is operable to apply, in the first group subfield with the smallest luminance weight, a waveform to the scan electrodes in the sustain period, the waveform including a rising ramp portion that is followed by a steeply rising portion.

41. The plasma display device according to claim 24, wherein
the drive unit is operable to apply, in the first group subfield with the smallest luminance weight, a waveform to the scan electrodes in the sustain period, the waveform including a single pulsed portion that raises and then decreases a voltage of the scan electrodes.

42. The plasma display device according to claim 24, wherein
the drive unit is operable to end a last one of sustain pulses applied during the sustain period relatively later in a subfield with a smaller luminance weight among the first group subfields than in a subfield with a larger luminance weight.

43. The plasma display device according to claim 24, wherein
the drive unit is operable to set, in a subfield subsequent to one of the first group subfields with a second smallest luminance weight, a most negative voltage during the reset period higher than a most negative voltage during the reset period of each of the other first group subfields.

44. The plasma display device according to claim 24, wherein
the drive unit is operable to drive the plasma display panel so that none of the discharge cells follows an ON-OFF pattern in which the discharge cell is turned ON in the subfield with the smallest luminance weight, turned OFF in an immediately subsequent subfield, and subsequently turned ON.
